(19) United States
(12) Patent Application Publication
(10) Pub. No.: US 2013/0339465 A1
(43) Pub. Date: Dec. 19, 2013

(54) METHOD, APPARATUS AND SYSTEM FOR SPREADING A MICROBLOG LIST

(71) Applicants: Li Zhang, Shenzhen City (CN); Jingjing LI, (US)

(72) Inventors: Li Zhang, Shenzhen City (CN); Jingjing LI, (US)

(73) Assignee: TENCENT TECHNOLOGY (SHENZHEN) COMPANY LIMITED, Shenzhen City, Guangdong (CN)

(21) Appl. No.: 14/000,590

(22) PCT Filed: Feb. 21, 2012
(86) PCT No.: PCT/CN12/00224

§ 371 Date: Sep. 4, 2013

(30) Foreign Application Priority Data
Feb. 21, 2011 (CN) 201110042017.X
Feb. 23, 2011 (CN) 201110043489.7
Mar. 2, 2011 (CN) 201110050116.2
Mar. 24, 2011 (CN) 201110072143.X

(51) Int. Cl. H04L 12/58

(52) U.S. Cl. CPC H04L 51/16
USPC 709/206

(57) ABSTRACT

Disclosed are a method, a terminal and a system for spreading a microblog list, relating to a network communication field and used for facilitating fast spreading of a microblog list. The method for spreading the microblog list includes: receiving, by a terminal, a microblog list sharing instruction issued by a user; automatically generating a microblog list sharing message according to basic information of a microblog list to be shared; and distributing the microblog list to be shared. According to the solution of the present disclosure, the microblog list sharing message which includes microblog lists that the user participates can be automatically generated at the microblog terminal. Thus, the user's operation is simplified and the microblog list can be spread fast and conveniently.

### CROSS REFERENCE TO RELATED APPLICATIONS

This application is the U.S. national phase of PCT/CN2012/000224, filed Feb. 21, 2012 and published in Chinese as WO 2012/113265 on Aug. 30, 2012. This application claims the benefit and priority of Chinese patent application No. 201110042017X, entitled “method, terminal and system for spreading a microblog list” filed on Feb. 21, 2011, Chinese patent application No. 2011100434897, entitled “method, apparatus and system for managing user group members” filed on Feb. 23, 2011, Chinese patent application No. 2011100501162, entitled “method for distributing a microblog message, microblog terminal and microblog server thereof” filed on Mar. 2, 2011, and Chinese patent application No. 201110072143X, entitled “microblog integrating method, microblog terminal, microblog list server, microblog topic server and system” filed on Mar. 24, 2011. The entire disclosures of each of the above applications are incorporated herein by reference.

### FIELD

The present disclosure relates to network communication techniques, and more particularly to a method, terminal and system for spreading a microblog list.

### BACKGROUND

With the development of Internet applications, microblog applications such as Twitter grow and develop rapidly. This kind of information distribution manner spreads and transmits information very fast via microblogs. Now, information transmission manner via microblog is not limited to traditional one-to-one friend chatting mode or one-to-more group message chatting mode in IM communication anymore. Microblog actually realizes a leap-forward development of the user chatting mode from one-to-one, one-to-more to one-to-infinite users. The one-to-infinite mode means that one user may spread a message to infinite users. Similarly, one user may also receive microblog messages distributed by millions of users at the same time. Therefore, applications with large amounts of users face new requirements.

When a user follows a relatively large number of users, he may classify these users according to different personal styles, different regions or different social circles and create a plurality of microblog lists accordingly. One microblog list may be seen as an aggregated user list created by the microblog user for a category of related microblog users. Certainly, if the user is interested in a kind of microblog topic, he may join the microblog list created by another user to listen to the microblog messages distributed by users in the microblog list.

Generally, the microblog user hopes to share the microblog list he creates or joins with other microblog users. In conventional microblog system, however, there is no such method which can spread the microblog list fast and conveniently.

### SUMMARY

Various examples of the present disclosure provide a method, a microblog terminal and a microblog server side for distributing a microblog message, so as to realize a one-to-more dialog between a user outside a microblog group and users inside the microblog group, improve the user's experience and make the product more competitive.

A method for distributing a microblog message, includes:

when a first user is to distribute a microblog message, obtaining, by a first microblog terminal corresponding to the first user, the microblog message to be distributed by the first user, and transmitting the microblog message to a microblog server side;

determining, by the microblog server side, whether a specific area of the microblog message comprises account information of a microblog group, if the specific area of the microblog message comprises the account information of the microblog group, adding, by the microblog server side, the microblog message into a specific message queue of each member of the microblog group; and

pushing, by the microblog server side, the microblog message in the specific message queue of each member of the microblog group to a microblog terminal corresponding to the member of the microblog group for distribution.

The specific area of the microblog message is a predetermined position arranged for a predefined regular expression.

The determining whether the specific area of the microblog message contains account information of the microblog group and adding the microblog message into a specific message queue of each member of the microblog group if the specific area of the microblog message comprises the account information of the microblog group includes:

parsing, by the microblog server side, the microblog message according to a regular matching principle, and determining, by the microblog server side, the specific area of the microblog message which matches the predetermined position arranged for the predefined regular expression;

determining, by the microblog server side, whether the specific area of the microblog message contains the account information of the microblog group;

if the specific area of the microblog message contains the account information of the microblog group, querying, by the microblog server side, a member account information group of the microblog group according to the account information of the microblog group; and

adding, by the microblog server side, the microblog message into the specific message queue of each member of the microblog group according to the member account information group.

The method further includes:

if the microblog server side determines that the specific area of the microblog message does not comprises the account information of the microblog group, determining, by the microblog server side, whether the specific area of the microblog message comprises account information of a second user;

if the specific area of the microblog message comprises the account information of the second user, adding, by the microblog server side, the microblog message to a specific message queue of the second user according to the account information of the second user;

scanning, by the microblog server side, the specific message queue of the second user, pushing the microblog message in the specific message queue of the second user to a second microblog terminal corresponding to the second user; and

displaying, by the second microblog terminal, the microblog message in the specific message queue of the second user on a specific message interface.

The pushing the microblog message in the specific message queue of each member of the microblog group to a microblog terminal corresponding to the member of the microblog group for distribution includes:

scanning, by the microblog server side, the specific message queue of each member of the microblog group, pushing the microblog message in the specific message queue of each member of the microblog group to a microblog terminal corresponding to the member of the microblog group; and

displaying, by the microblog terminal corresponding to each member of the microblog group, the microblog message in the specific message queue of the member of the microblog group.

The displaying the microblog message in the specific message queue of the member of the microblog group by the microblog terminal corresponding to each member of the microblog group includes:

displaying, by the microblog terminal corresponding to each member of the microblog group, a display prompt and a review link for the microblog message in the specific message queue for the member of the microblog group; and

if the member of the microblog group operates the review link, displaying, by the microblog terminal corresponding to the member of the microblog group, the microblog message in the specific message queue on a specific message interface.

After the microblog server side pushes the microblog message in the specific message queue of each member of the microblog group to the microblog terminal corresponding to each member of the microblog group for distribution, the method further includes:

if the member of the microblog group responses to or forwards the microblog message in the specific message queue distributed by the first user, obtaining, by the microblog terminal corresponding to the member, response contents or forward contents, encapsulating the account information of the microblog group and the response contents or the forward contents to generate a response message or forward message, and transmitting the generated response message or forward message to the microblog server side;

adding, by the microblog server side, the response message or the forward message to a broadcast queue of the microblog group according to the account information of the microblog group in the response message or the forward message;

scanning, by the microblog server side, the broadcast queue of the microblog group, pushing the microblog message in the broadcast queue of the microblog group to the first microblog terminal; and

displaying, by the first microblog terminal, the microblog message in the broadcast queue of the microblog group on a group message page.

Accordingly, an example of the present disclosure provides a microblog terminal, includes:

a microblog message managing module, adapted to manage a microblog message, when a user is to distribute a microblog message, obtain the microblog message to be distributed, and transmit the microblog message to the microblog server; and

a special message interface managing module, adapted to receive the microblog message in the specific message queue of the user transmitted by the microblog server side, and display the microblog message in the specific message queue of the user on a specific message interface.

The microblog terminal further includes:

a microblog group managing module, adapted to manage a microblog group, receive a microblog message in a broadcast queue of the microblog group transmitted by the microblog server, and display the microblog message in the broadcast queue of the microblog group in a group message page; and

a microblog message prompting module, adapted to provide a displaying prompt and a review link for the microblog message in the specific message queue and/or the microblog message in the broadcast queue of the microblog group, and notify the specific message managing module and/or the microblog group managing module to display the corresponding microblog message when the user operates the review link.

The microblog message managing module is further adapted to obtain, when the user of the microblog terminal returns or forwards a microblog message in the @ message queue as a member of a microblog list, contents returned or forwarded by the user, encapsulate the account information of the microblog list and the contents returned or forwarded by the user to generate a response message or a forward message and transmit it to the microblog server side.

Accordingly, an example of the present disclosure further provides a microblog server side, including:

a microblog list server, adapted to store and manage basic information of a microblog list; the basic information of the microblog list includes microblog group account information and member account information list;

a microblog message server, adapted to determine whether a microblog message transmitted by a first microblog terminal contains microblog group account information in a specific area, if yes, add the microblog message to the specific message queue of each member of the microblog list; and

a microblog message pushing server, adapted to scan the specific message queue of each member of the microblog list after the adding operation of the microblog message server, push, for each member of the microblog list, the microblog message in the specific message queue of the member of the microblog list to the microblog terminal corresponding to the member of the microblog list for distribution.

The microblog message server includes:

a parsing unit, adapted to parse a microblog message transmitted by a microblog terminal according to a regular matching principle and determine a specific area of the microblog message which matches the pre-determined area arranged for a pre-defined regular expression;

a detecting unit, adapted to determine whether the specific area of the microblog message contains microblog group account information according to the specific area of the microblog message determined by the parsing unit; and

a first operating unit, adapted to search the microblog list server for a member account information list if the detecting unit determines that the account information is the microblog group account information, and add the microblog message to a specific message queue of each member of the microblog list according to the member account information list.

The microblog server side further includes:

a microblog user server, adapted to store and manage basic information of the microblog user, wherein the basic information of the microblog user includes user account information;

the microblog message server further includes:

a determining unit, adapted to determine whether the specific area of the microblog message contains account information of a second user if the detecting unit determines that the account information is not the microblog group account information; and

a second operating unit, adapted to add the microblog message to a specific message queue of the second user according to the account information of the second user if the determining unit determines that the account information is of the second user, and notify the microblog message pushing server to push the microblog message in the specific message queue of the second user to the second microblog terminal corresponding to the second user for distribution.

When a member of the microblog list responses to or forwards the microblog message distributed by the first user in the specific message queue of the member, the microblog message server is further adapted to receive the response message or the forward message transmitted by the microblog terminal corresponding to the member, add the response message or forward message to the broadcast queue of the microblog list according to the microblog group account information in the response message or forward message, and notifies a microblog message pushing server to push the microblog message in the broadcast queue of the microblog list to the first microblog terminal for distribution.

The method, microblog terminal and microblog server side provided by the examples of the present disclosure have the following advantages.

1. A user may input microblog group account information in the microblog message to be distributed. The microblog server side detects the microblog message to be distributed. If it is detected that the specific area of the microblog message contains the microblog group account information, the microblog message is added to the specific message queue (e.g., @ message queue) of each member of the microblog list. The microblog message in the specific message queue of each member of the microblog list is pushes to the microblog terminal corresponding to each member of the microblog list for distribution, which realizes the one-to-more dialog between a single user (user inside the microblog list or outside the microblog list) and each member of the microblog list, improves user's experience and makes the product more competitive

2. Each member in the microblog list may response to or forward the received microblog message in the specific message queue. The microblog terminal corresponding to each member encapsulates the microblog group account information and the response contents or forward contents to generate a response message or a forward message and transmits the message to the microblog server side. The microblog server side adds the response message or the forward message to the broadcast queue of the microblog list according to the microblog group account information and pushes to the transmitter (the single microblog user), which realizes the more-to-one dialog between the microblog list to the single microblog user (user inside the microblog group or outside of the microblog group). The product is more competitive.

Various examples of the present disclosure further provide a microblog integrating method, a microblog terminal, a microblog list server, a microblog topic server and a system thereof, so as to realize microblog information integration and provide users with more information.

A microblog integrating method is provided. The method includes:

querying, by a microblog terminal, a microblog topic server according to topic content, and obtaining a topic identifier of a topic corresponding to the topic content;

transmitting an establishing instruction to a microblog list server and/or the microblog topic server to establish an association relationship between the topic and a microblog list that the microblog terminal belongs to, wherein the establishing instruction comprises the topic identifier and a microblog list identifier; the association relationship comprises a mapping relationship and/or a listening relationship;

finding, by the microblog list server, data contents corresponding to the microblog list identifier according to the microblog list identifier and writing the topic identifier into the data content to establishing the mapping relationship; and/or

obtaining, by the microblog topic server, the topic identifier of the topic, finding data contents corresponding to the topic identifier and writing the microblog list identifier into the data contents to establish the listening relationship.

After finding the data contents corresponding to the microblog list identifier according to the microblog list identifier and writing the topic identifier into the data content to establishing the mapping relationship, the method further includes:

transmitting, by a microblog message server, a microblog message transmitted by a microblog member of the microblog list to a message list of the topic having the mapping relationship with the microblog list.

The transmitting the microblog message transmitted by the microblog member of the microblog list to the message list of the topic having the mapping relationship with the microblog list includes:

obtaining, by the microblog message server, the microblog list identifier corresponding to the microblog member, determining the topic identifier which has the mapping relationship with the microblog list identifier, and writing the microblog message into the message list of the topic identifier.

After obtaining the topic identifier of the topic and finding data contents corresponding to the topic identifier and writing the microblog list identifier into the data contents to establish the listening relationship, the method further includes:

parsing, by a microblog message server, a microblog message received, obtaining topic content of the microblog message and querying the microblog topic server to determine whether there is same topic content;

if there is the same topic content, transmitting, by the microblog message server, an insert instruction to the microblog topic server to insert the a microblog message identifier to a message list of the topic; and

if there is no same topic content, creating, by the microblog topic server, a new topic according to the topic content.

An example of the present disclosure further provides a microblog terminal, including:

an obtaining module, adapted to query a microblog topic server according to topic content and obtain a topic identifier of a topic corresponding to the topic content;

an instruction transmitting module, adapted to transmit an establishing instruction for establishing an association relationship between the topic and a microblog list that the microblog terminal 380 belongs to a microblog list server and/or the microblog topic server; the establishing instruction includes the topic identifier and a microblog list identifier; the association relationship includes a mapping relationship and/or a listening relationship; and

a writing requesting module, adapted to find data content corresponding to the microblog list identifier according to the microblog list identifier through the microblog list server, and write the topic identifier into the data content to establish the mapping relationship; and/or

obtain the topic identifier of the topic through the microblog topic server, find the data content corresponding to the topic and write the microblog list identifier into the data content to establish the listening relationship.

An example of the present disclosure further provides a microblog list server, including:

a list instruction receiving module, adapted to receive an establishing instruction transmitted by a microblog terminal for establishing a mapping relationship between a topic and a microblog list that the microblog terminal belongs to; wherein the establishing instruction includes a topic identifier and a microblog list identifier; and

a list searching module, adapted to find data content corresponding to the microblog list identifier according to the microblog list identifier and write the topic identifier into the data content.

An example of the present disclosure further provides a microblog topic server, including:

a topic instruction receiving module, adapted to receive an establishing instruction for establishing a listening relationship between a topic and a microblog list that a microblog terminal belongs to transmitted by a microblog terminal; the establishing instruction includes a topic identifier and a microblog list identifier; and

a topic searching module, adapted to obtain the topic identifier of the topic, find data content corresponding to the topic identifier and write the microblog list identifier into the data content to establish the listening relationship.

An example of the present disclosure further provides a microblog system, including: a microblog terminal, a microblog topic server and/or a microblog list server; the microblog terminal is adapted to:

query the microblog topic server according to topic content and obtain a topic identifier of a topic corresponding to the topic content;

transmit an establishing instruction for establishing an association relationship between a topic and a microblog list that the microblog terminal belongs to the microblog list server and/or the microblog topic server; the establishing instruction includes a topic identifier and a microblog list identifier; the association relationship includes a mapping relationship and/or a listening relationship;

the microblog list server is adapted to:

find the data content corresponding to the microblog list identifier according to the microblog list identifier and write the topic identifier into the data content to establish the mapping relationship; and

the microblog topic server is adapted to:

obtain the topic identifier of the topic, find the data content corresponding to the topic identifier, write the microblog list identifier into the data content to establish the listening relationship.

The microblog system further includes a microblog message server, adapted to transmit a microblog message transmitted by a microblog member in the microblog list to a message list of the topic having mapping relationship with the microblog list.

The microblog message server is adapted to obtain the microblog list identifier corresponding to the microblog member, determine the topic identifier having the mapping relationship with the microblog list identifier and write the microblog message into the message list of the topic identifier.

The microblog message server is further adapted to: parse the received microblog message, obtain topic content and query the microblog topic server to determine whether there is the same topic content; transmit an inserting instruction to the microblog topic server if there is, and insert the topic content to the message list of the corresponding topic; and

the microblog topic server is further adapted to generate a new topic according to the topic content if there is no same topic content.

In the above microblog system, the microblog list associated with the topic may be seen via a topic displaying manner of the microblog list. Thus, one user may find from the topic a microblog list associated with the topic and decide to follow or attempt to follow this microblog list. At the same time, the creating user of the microblog list may make the microblog messages distributed by microblog members (microblog terminals) automatically be added into the message list of the associated topic through establishing the mapping relationship between the microblog list and the topic. As such, a microblog terminal listening to this topic can see microblog messages distributed by the microblog terminals, which realizes the integration of the microblog topic and the microblog list. The microblog terminals may get more resources and the user's experience is improved.

### BRIEF DESCRIPTION OF THE DRAWINGS

The drawings used in the description of various examples are briefly described hereinafter to make the technical solution of the examples or the prior art clearer. The drawings described herein are for illustrative purposes only of selected examples and not all possible implementations. Variations and modifications may be obtained by those skilled in the art without departing from the principle of the present disclosure.

FIG. 1 is a flowchart illustrating a method for spreading a microblog list according to an example of the present disclosure.

FIG. 2 is a schematic diagram illustrating a structure of a microblog terminal according to an example of the present disclosure.

FIG. 3 is a schematic diagram illustrating a structure of a system for spreading a microblog list according to an example of the present disclosure.

FIG. 4 is a flowchart illustrating a method for spreading a microblog list according to another example of the present disclosure.

FIG. 5 shows a microblog list page according to an example of the present disclosure.

FIG. 6 shows a microblog broadcast distribution window page according to an example of the present disclosure.

FIG. 7 shows a broadcast message page of a shared microblog list received by other users according to an example of the present disclosure.

FIG. 8 is a schematic diagram illustrating a structure of a microblog terminal according to an example of the present disclosure.

FIG. 9 is a flowchart illustrating a method of managing user group members by a server side according to an example of the present disclosure.

FIG. 10 is a flowchart illustrating a method of managing user group members by a client side according to an example of the present disclosure.

FIG. 11 is a flowchart illustrating a method for managing user group members according to an example of the present disclosure.

FIG. 12 is flowchart illustrating a method for managing user group members according to an example of the present disclosure.

FIG. 13 is a flowchart illustrating another method for managing user group members according to an example of the present disclosure.

FIG. 14 is a flowchart illustrating another method for managing user group members according to an example of the present disclosure.

FIG. 15 is a schematic diagram illustrating a structure of a server according to an example of the present disclosure.

FIG. 16 is a schematic diagram illustrating a structure of a server according to an example of the present disclosure.

FIG. 17 is a schematic diagram illustrating a structure of a server according to an example of the present disclosure.

FIG. 18 is a schematic diagram illustrating a structure of a server according to an example of the present disclosure.

FIG. 19 is a schematic diagram illustrating a structure of a server according to an example of the present disclosure.

FIG. 20 is a schematic diagram illustrating a structure of a server according to an example of the present disclosure.

FIG. 21 is a schematic diagram illustrating a structure of a server according to an example of the present disclosure.

FIG. 22 is a schematic diagram illustrating a structure of a client according to an example of the present disclosure.

FIG. 23 is a schematic diagram illustrating a structure of a client according to an example of the present disclosure.

FIG. 24 is a schematic diagram illustrating a structure of a client according to an example of the present disclosure.

FIG. 25 is a schematic diagram illustrating a structure of a client according to an example of the present disclosure.

FIG. 26 is a schematic diagram illustrating a structure of a system for managing user group members according to an example of the present disclosure.

FIG. 27 is a schematic diagram illustrating a first structure of a microblog terminal according to an example of the present disclosure.

FIG. 28 is a schematic diagram illustrating a second structure of a microblog terminal according to an example of the present disclosure.

FIG. 29 is a schematic diagram illustrating a first structure of a microblog server side according to an example of the present disclosure.

FIG. 30 is a schematic diagram illustrating a second structure of a microblog server side according to an example of the present disclosure.

FIG. 31 is a schematic diagram illustrating a structure of a microblog message server according to an example of the present disclosure.

FIG. 32 is a flowchart illustrating a first method for distributing a microblog message according to an example of the present disclosure.

FIG. 33 is a flowchart illustrating a second method for distributing a microblog message according to an example of the present disclosure.

FIG. 34 is a flowchart illustrating a third method for distributing a microblog message according to an example of the present disclosure.

FIG. 35 is a flowchart illustrating a microblog integrating method according to an example of the present disclosure.

FIG. 36 is a flowchart illustrating a microblog integrating method according to an example of the present disclosure.

FIG. 37 is a flowchart illustrating a process of determining whether there are same topic in the microblog integrating method according to an example of the present disclosure.

FIG. 38 is a schematic diagram illustrating a structure of a microblog terminal according to an example of the present disclosure.

FIG. 39 is a schematic diagram illustrating a structure of a microblog list server according to an example of the present disclosure.

FIG. 40 is a schematic diagram illustrating a structure of a microblog list server according to an example of the present disclosure.

FIG. 41 is a schematic diagram illustrating a microblog system according to an example of the present disclosure.

### DETAILED DESCRIPTION

Hereinafter, the present disclosure is described in further detail with reference to the accompanying drawings and examples to make the technical solution therein clear and to provide a thorough understanding of the present disclosure. The examples in the following description are set forth by way of illustration only and are not meant as limitations. It will be readily apparent however, that the present disclosure may be practiced without limitation to these specific details. Many variations are possible within the spirit and scope of the disclosure.

At current stage of network development, microblog has grown fast acting as a new application for extending the IM message transmission scheme. In the microblog field, users have looser relations and are in a universal relation chain. In other words, one user may follow any other microblog user and receive microblog messages distributed by this microblog user according to his interests and hobbies. No authentication is required. For example, if the user sees a broadcast message and is interested in the user distributing this broadcast message, the user may directly follow the user distributing the broadcast message. Thus, the broadcast message is spread faster and more broadly. A microblog list is a managing manner for managing a group of microblog users that one microblog user is interested in. A member of a microblog list may be a user that the microblog user follows or not. Currently, management functions are provided for the microblog list, e.g., management of resources and members. But the universal relation chain of the microblog and the spreading feature of the broadcast message are not combined enough.

Examples of the present disclosure provide a method for spreading a microblog list. The method is a microblog list sharing solution based on broadcast of microblog utilizing the universal relation chain of microblog and the spreading feature of broadcast messages.

Hereinafter, the method for spreading a microblog list provided by various examples of the present disclosure is described more fully with reference to the accompanying drawings.

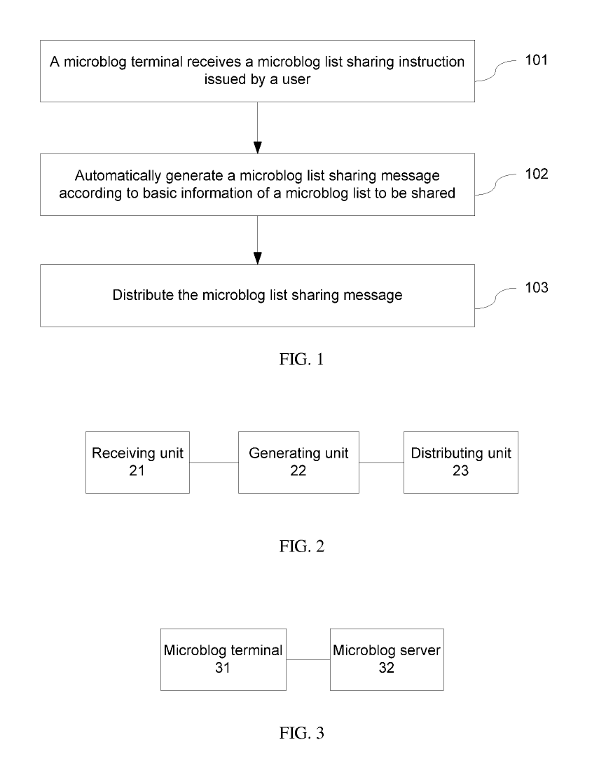

FIG. 1 is a flowchart illustrating a method for spreading a microblog list according to an example of the present disclosure. With reference to FIG. 1, the method includes the following.

At block 101, a microblog terminal receives a microblog list sharing instruction issued by a user.

The microblog list sharing instruction may be issued by the user via inputting codes. Preferably, the microblog terminal may configure a control button on a displayed microblog page or a microblog list page. The user may issue the microblog list sharing instruction to the microblog terminal through clicking the control button using a mouse.

At block 102, a microblog list sharing message is generated automatically according to basic information of the microblog list to be shared.

The basic information of the microblog list includes at least a name of the microblog list and an address corresponding to the microblog list.

At block 103, the microblog list sharing message is distributed.

After receiving a distribution instruction issued by the user, the microblog terminal may transmit the generated microblog list sharing message to a microblog server through which the microblog list sharing message is distributed.

In accordance with the above method, an example of the present disclosure provides a microblog terminal for spreading a microblog list. With reference to FIG. 2, the microblog terminal includes:

a receiving unit 21, adapted to receive a microblog list sharing instruction issued by a user;

a generating unit 22, adapted to automatically generate a microblog list sharing message according to basic information of a microblog list to be shared; and

a distributing unit 23, adapted to distribute the microblog sharing message.

The above method and microblog terminal may be applied in a network communication system to form a microblog list spreading system. With reference to FIG. 3, the microblog list spreading system may include: a microblog terminal 31 and a microblog server 32; wherein

the microblog terminal 31 is adapted to receive a microblog list sharing instruction issued by a user; automatically generate a microblog list sharing message according to basic information of a microblog list to be shared; and distribute the microblog sharing message via the microblog server 32.

In the above examples, after receiving the microblog list sharing instruction issued by the user, the microblog terminal automatically generates a microblog list sharing message including information of a microblog list that the user participates in, i.e., a microblog list that the user creates or joins, and distributes the microblog list sharing message via the microblog server. This procedure simplifies operations of the user. Therefore, the microblog list may be spread fast and conveniently.

Hereinafter, the method and the corresponding microblog terminal will be described in further detail with reference to the various examples.

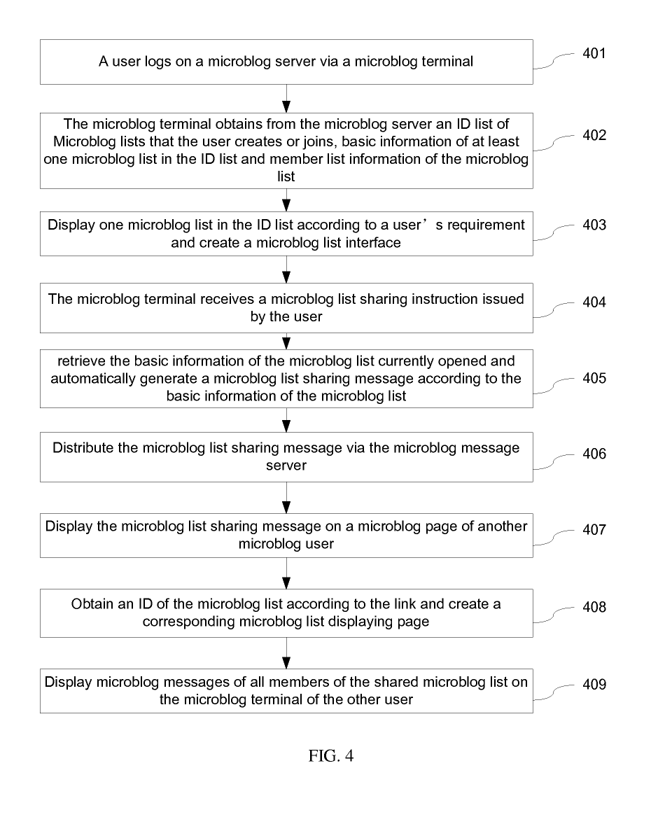

FIG. 4 is a flowchart illustrating a method for spreading a microblog list according to an example of the present disclosure. With reference to FIG. 4, the method includes the following.

At block 401, a user logs on a microblog server via a microblog terminal.

In particular, the user inputs an account and a password of the user via the microblog terminal. The microblog terminal transmits the account and the password to a logon server to perform user identity authentication. After the authentication is passed and the user successfully logs on, a connection tunnel between the microblog terminal and the logon server is established. In addition, the microblog terminal needs to transmit heartbeat packets periodically to maintain the connection between the microblog terminal and the logon server.

In this example, the microblog terminal may be but is not limited to an Instant Messaging (IM) client. The user may implement interface operations and information exchange via the microblog terminal.

At block 402, after the user successfully logs on the microblog server, the microblog terminal obtains from the microblog server an ID list of microblog lists that the user participates in and basic information corresponding to at least one microblog list in the ID list and member list information in the microblog list.

In particular, a microblog group managing module at a microblog terminal side transmits to a microblog user server at a microblog server side a protocol instruction to obtain the ID list of the microblog lists that the user participates in. A data packet corresponding to the protocol instruction carries a ID corresponding to the user. The microblog list that the user participates in may be a microblog list created by the user or a microblog list that the user joins.

After receiving the data packet corresponding to the protocol instruction, the microblog user server analyzes the data packet and obtains the number identifier of the user from the data packet, searches a database according to the number identifier of the user to obtain the ID list of the microblog lists that the user participates in and returns the ID list to the microblog terminal.

The microblog terminal queries a microblog list server for basic information of microblog lists in the ID list and member list information of each microblog list according to the ID list returned by the microblog user server. After obtaining the basic information of the microblog lists and the member list information of each microblog list, the microblog terminal saves them in a local file.

The microblog group managing module at the microblog terminal side is mainly used for retrieving and saving information and member list associated with the microblog list, and for creating a microblog list displaying page for displaying the retrieved information data associated with the microblog list.

The microblog user server at the microblog server side is mainly used for saving a following relation of microblog users and user basic information such as basic information, user type, and user label attribute.

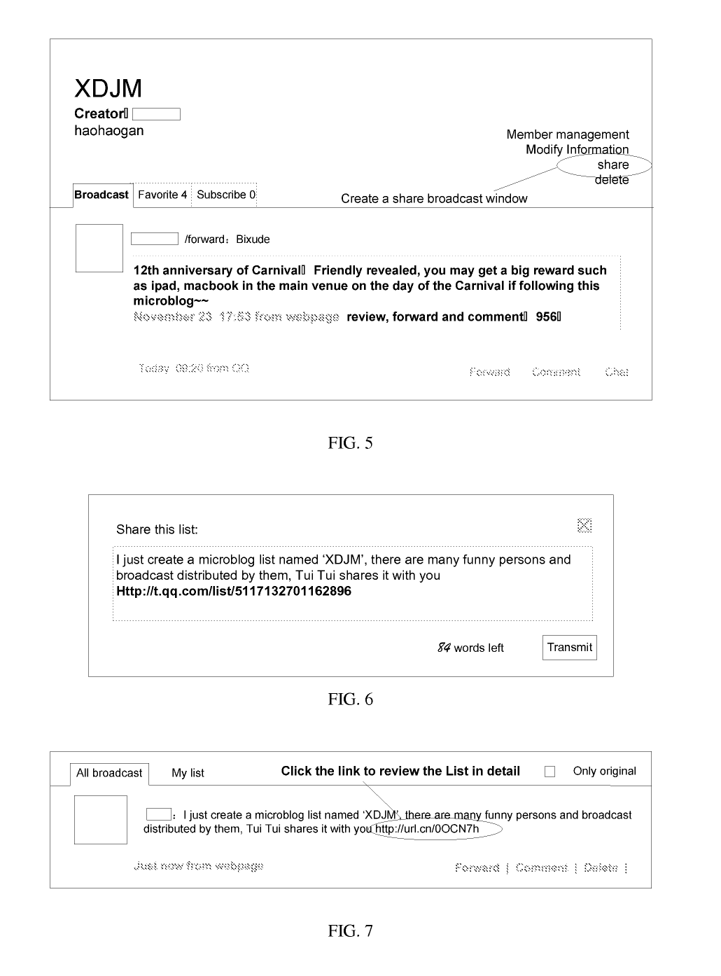

At block 403, after obtaining the ID list and the basic information and the member list information of at least one microblog list in the ID list, the microblog terminal may select one microblog list for display according to a user's requirement and create a microblog list interface as shown in FIG. 5.

At block 404, the microblog terminal receives a microblog list sharing instruction issued by the user.

In particular, the microblog terminal may monitor a mouse clicking operation of the user and determine whether the user issues a microblog list sharing instruction through determining whether the user clicks a “share” button on the microblog list interface as shown in FIG. 5, i.e., once the user clicks the “share” button, the microblog terminal receives the microblog list sharing instruction.

At block 405, the microblog terminal retrieves the basic information of the microblog list currently opened from a local storage and automatically generates a microblog list sharing message according to the basic information of this microblog list.

In this example, the microblog list currently opened is the microblog list to be shared.

In particular, the basic information of the microblog list may be combined with default information saved in the microblog terminal to form contents of the microblog list sharing message. Then, a microblog broadcast distribution window is created on the current microblog list page and the contents of the microblog list sharing message is filled in the microblog broadcast distribution window.

With reference to FIG. 6, the default message may be “I just created a microblog list named ‘****’, there are many funny people and broadcast distributed by them, TuiTui shares it with you http://***”. During a practical distribution procedure, sections denoted by * in the default message may be replaced by different microblog list names and/or addresses corresponding to the microblog lists.

At block 406, the microblog terminal monitors the “transmit” button on the microblog broadcast distribution window to determine whether there a mouse operation. If the “transmit” button is clicked, a microblog message managing module encapsulates the contents of the microblog list sharing message and the number identifier of the user in a data packet and transmits the data packet to a microblog message server at the microblog server side. Then, the microblog list sharing message is distributed via the microblog message server.

The microblog message server generates a corresponding microblog message ID and puts it into a distributed message ID list corresponding to the user.

The microblog message managing module is at the microblog terminal side and is mainly used for performing protocol instruction interaction with the microblog message server at the microblog server side, so as to implement the retrieving of a microblog message ID list and retrieving and displaying of contents of each message. The microblog message managing module is also responsible for the creating and managing of the microblog message broadcast distribution window.

The microblog message server is mainly used for managing a mapping relationship between a microblog message index (message ID) and a message body (message contents). The microblog terminal may retrieve a corresponding message body according to the microblog message index.

At block 407, the microblog list sharing message is displayed on a microblog page of another microblog user.

When another microblog user reviews his microblog homepage messages, the microblog terminal of this microblog user will retrieve a distributed message queue corresponding to the number identifier of the microblog user that this microblog user follows and return the distributed message queue to the homepage corresponding to the microblog terminal according to a time sequence.

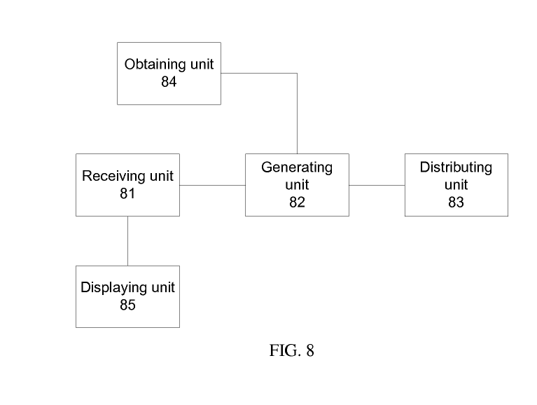

In particular, the message ID list is transmitted to the microblog message managing module of the microblog terminal. According to the message contents corresponding to each message ID retrieved by the microblog message managing module, a microblog message displaying page similar to FIG. 7 may be created. The link shown in FIG. 7 corresponds to the address of the microblog list to be shared.

At block 408, the microblog message managing module of the microblog terminal monitors a mouse clicking operation of the user in each message body. If the link displayed in FIG. 7 is clicked, the microblog terminal obtains an ID of the corresponding microblog list according to the link, creates a corresponding microblog list displaying page, and retrieves the basic information of the microblog list and a member number list according to the ID of the microblog list.

At block 409, microblog messages of all of the members in the shared microblog list are displayed on the microblog terminal of the other microblog user.

A displaying controller is created according to the basic information of the microblog list to display information such as name. According to the member number list, the newest distributed message ID list corresponding to the member number list is retrieved from the microblog message server. And detailed message contents are retrieved according to the newest distributed message ID list. Thus, the other microblog user may see the newest messages distributed by all of the members in the shared microblog list. Through this kind of universal relation chain, the microblog list may be shared fast, which greatly extends the usage crowd of the microblog list.

Furthermore, after seeing the shared microblog list, if the other user is interested in the shared microblog list, the user may join the microblog list conveniently. Therefore, the method is good for rapid spread of the microblog list.

In the method for spreading the microblog list described through the above blocks, the microblog list sharing instruction is triggered by the user through clicking a “share” button on the microblog list page. Besides this, the microblog user may also click a “share” button configured on the microblog page of the user to trigger the microblog list sharing instruction.

Since one microblog user may participate in more than one microblog list, after receiving the microblog list sharing instruction and before automatically generating the microblog list sharing message according to the basic information of the microblog list to be shared, the microblog terminal may further perform the following operations.

After the user clicks the “share” button, the microblog terminal displays a list of all of the microblog lists that the user participate in, so as to facilitate the user to select at least one microblog list from them.

The user selects at least one microblog list from the displayed microblog lists as the microblog list to be shared, and submits the selected microblog list.

After the user submits the selected microblog list, the microblog terminal obtains information of the at least one microblog list selected by the user.

Then, the microblog terminal automatically generates the microblog list sharing message according to the basic information corresponding to the at least one microblog list selected by the user.

In accordance with the above method, an example of the present disclosure provides a microblog terminal to implement the above method. With reference to FIG. 8, the microblog terminal includes: a receiving unit 81, a generating unit 82 and a distributing unit 83; wherein

the receiving unit 81 is adapted to receive a microblog list sharing instruction issued by a user;

the generating unit 82 is adapted to automatically generate a microblog list sharing message according to basic information of the microblog list to be shared; and

the distributing unit 83 is adapted to distribute the microblog list sharing message.

In addition, in this example, the microblog terminal further includes an obtaining unit 84, adapted to obtain from a microblog server the basic information of at least one microblog list that the user participates in.

The microblog list to be shared may be a microblog list currently opened by the user; or, the microblog list to be shared may be at least one microblog list of all of the microblog lists that the user participates in.

In the case that the microblog list to be shared is at least one of the microblog lists that the user participates in, a displaying unit 85 is further configured in the microblog terminal, such that the user can select the microblog list to be shared from the microblog lists that the user participates in.

The displaying unit 85 is adapted to display a list of all of the microblog lists that the user participates in, such that the user can select at least one microblog list from them.

The receiving unit 81 is further adapted to receive information of the at least one microblog list selected by the user according to the microblog lists displayed by the displaying unit.

The generating unit 82 is further adapted to automatically generate the microblog list sharing message according to the basic information of the at least one microblog list selected by the user.

In this example, the user may distribute the microblog list that the user creates or joins in form of microblog broadcast. The message contents may carry a displaying page link corresponding to the microblog list. Thus, after seeing the broadcast message, other microblog users may click the microblog list displaying page link in the message to view an aggregated message list of all members of the microblog list. The other users may select to subscribe to this microblog list or join this microblog list after reading the messages. Thus, the microblog list may be spread fast through the universal relation chain of the microblog and the rapid spread of the message, which makes each microblog list be spread fast and grow fast.

The method for spreading the microblog list, the terminal and the system provided by the examples of the present disclosure are applicable for any microblog system.

The group function of a traditional IM tool is realized as follows: a user obtains information of a user group he wants to join, transmits a join request to the server via a client. The join request includes the ID of the user and the information of the user group that the user wants to join. The server receives the join request, transmits a join request notification to a manager of the user group according to the information of the user group. If the manager of the user group agrees, the user is allowed to join the user group.

The group function of the IM tool is a closed user set. One user can request to join a user group if only the information of the user group he wants to join is acquired. Other users cannot recommend the user to a group.

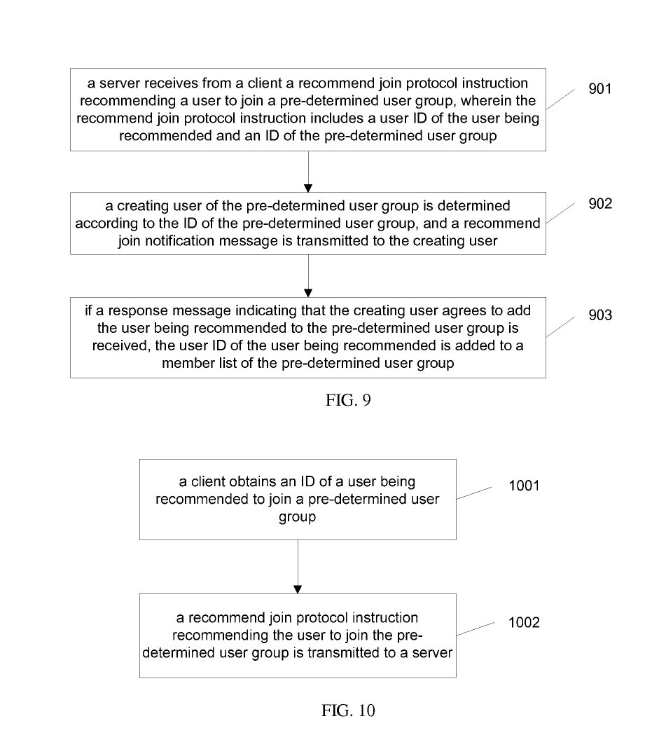

Therefore, an example of the present disclosure further provides a method for managing a user group member, applied to a server side. With reference to FIG. 9, the method includes the following.

At block 901, a server receives from a client a recommend join protocol instruction recommending a user to join a pre-determined user group, wherein the recommend join protocol instruction includes a user ID of the user being recommended and an ID of the pre-determined user group.

At block 902, a creating user of the pre-determined user group is determined according to the ID of the pre-determined user group, and a recommend join notification message is transmitted to the creating user, such that the creating user determines whether to add the user being recommended to the pre-determined user group.

It should be noted that, when a user creates a user group, the server may record relevant information of the creation of the user group and save the relevant information in form of a data table. The relevant information includes information such as a user group name, a user group ID and the creating user. When the server needs to obtain the creating user of the user group, it only needs to query the relevant information data table according to the user group ID. Then, the creating user of the user group is obtained. Therefore, in the example of the present disclosure, the determination of the creating user of the pre-determined user group according to the user group ID may include: querying the relevant information data table of the user group according to the user group ID to determine the creating user of the user group.

At block 903, if a response message indicating that the creating user agrees to add the user being recommended to the pre-determined user group is received, the user ID of the user being recommended is added to a member list of the pre-determined user group.

An example of the present disclosure further provides a method for managing a user group member, applied to a client side. With reference to FIG. 10, the method includes the following.

At block 1001, a client obtains an ID of a user being recommended to join a pre-determined user group.

The obtaining of the ID of the user being recommended to join the pre-determined user group may include: the client receives the ID of the user being recommended inputted by the user via an interface operation, or the client receives the ID of the user being recommended selected by the user from displayed user groups via an interface operation. The detailed obtaining method is not restricted in the present disclosure. Any method capable of obtaining the ID of the user being recommended to join the pre-determined user group is within the protection scope of the present disclosure.

At block 1002, a recommend join protocol instruction recommending the user to join the pre-determined user group is transmitted to a server, wherein the recommend join protocol instruction includes the ID of the user being recommended and the ID of the pre-determined user group.

In the example of the present disclosure, when a user needs to recommend a user in one user group to another user group, the ID of the user being recommended to join the pre-determined user group is obtained, and a recommend join protocol instruction recommending the user to join the pre-determined user group is transmitted to the server. After receiving the recommend join protocol instruction, the server determines the creating user of the pre-determined user group according to the ID of the pre-determined user group, and transmits a recommend join notification message to the creating user. If a response message indicating that the creating user agrees to add the user being recommended to the pre-determined user group is received, the ID of the user being recommended is added to the member list of the pre-determined user group. Thus, it is realized that one user recommends other users to the pre-determined user group, which facilitates the extension of the user group greatly.

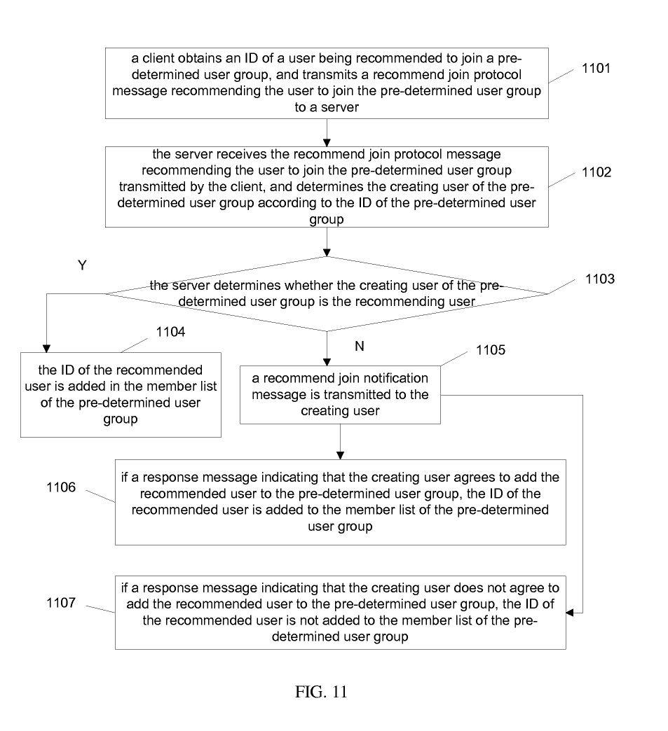

An example of the present disclosure further provides a method for managing a user group. With reference to FIG. 11, the method includes the following operations.

At block 1101, a client obtains an ID of a user being recommended to join a pre-determined user group, and transmits a recommend join protocol message recommending the user to join the pre-determined user group to a server, wherein the recommend join protocol message includes the ID of the user being recommended and the ID of the pre-determined user group.

At block 1102, the server receives the recommend join protocol message recommending the user to join the pre-determined user group transmitted by the client, and determines the creating user of the pre-determined user group according to the ID of the pre-determined user group.

At block 1103, the server determines whether the creating user of the pre-determined user group is the recommending user according to the ID of the recommending user; if the creating user of the pre-determined user group is the recommending user, block 1104 is performed; otherwise, block 1105 is performed.

At block 1104, the ID of the recommended user is added in the member list of the pre-determined user group.

At block 1105, a recommend join notification message is transmitted to the creating user, such that the creating user determines whether to add the recommended user to the pre-determined user group.

At block 1106, if a response message indicating that the creating user agrees to add the recommended user to the pre-determined user group, the ID of the recommended user is added to the member list of the pre-determined user group.

At block 1107, if a response message indicating that the creating user does not agree to add the recommended user to the pre-determined user group, the ID of the recommended user is not added to the member list of the pre-determined user group.

Furthermore, after the ID of the recommended user is added to the member list of the pre-determined user group, the method may further include:

transmitting a notification message to the recommending user notifying the recommending user that the recommended user has been added to the pre-determined user group, such that the client of the recommending user may create a prompt interface corresponding to the notification message to prompt the recommending user of the join status of the recommended user; and/or

transmitting a notification message to the recommended user notifying the recommended user that the recommended user has been added to the pre-determined user group, such that the client of the recommended user may create a prompt interface corresponding to the notification message to prompt that the recommended user has joined the user group.

Furthermore, when the user recommends a user to the pre-determined user group, the user may recommend one user each time as described in blocks 1101 to 1107, or recommend a plurality of users at one time. In the case that the user recommends a plurality of users at one time, in block 1101, the client obtains the IDs of the plurality of users being recommended to join the pre-determined user group. When transmitting the recommend join protocol instruction, the client puts the plurality of user IDs in the recommend join protocol instruction in form of a recommended user ID list. The server performs the recommend join operation as described in blocks 1102 to 1107 with respect to each recommended user in the recommended user ID list. The detailed operations are not repeated herein.

In an example of the present disclosure, when a user needs to recommend a user in one user group to another user group, the ID of the user being recommended to join the pre-determined user group is obtained and a recommend join protocol instruction recommending the user to join the pre-determined user group is transmitted to a server. After receiving the recommend join protocol instruction, the server determines a creating user of the pre-determined user group according to the ID of the pre-determined user group and transmits a recommend join notification message to the creating user. If a response message indicating that the creating user agrees to add the recommended user to the pre-determined user group, the ID of the recommend user is added to the member list of the pre-determined user group. Thus, it is realized that one user can recommend other users to the pre-determined user group, which facilitates the extension of the user group. Furthermore, when the user recommends users to the pre-determined user group, the user may recommend a plurality of users at one time. Thus, it is avoided that one recommend join protocol instruction is transmitted to the server each time that one user is recommended, which saves resources and facilitates the extension and creation of the user group greatly.

In addition, in the example of the present disclosure, if the recommending user is the creating user of the pre-determined user group, the ID of the recommended user is directly added to the member list of the pre-determined user group, which omits the acknowledgement of the creating user of the pre-determined user group, accelerates the join procedure of the recommended user.

Furthermore, after the ID of the recommended user is added to the member list of the pre-determined user group, an example of the present disclosure may further transmit a notification message to the recommending user indicating that the recommended user has been added to the pre-determined user group, which facilitates the recommending user to acquire the join status of the recommended user. In addition, a notification message indicating that the recommended user has been added in the pre-determined user group may be transmitted to the recommended user, which facilitates the recommended user to know the user group he joins and improves user experience.

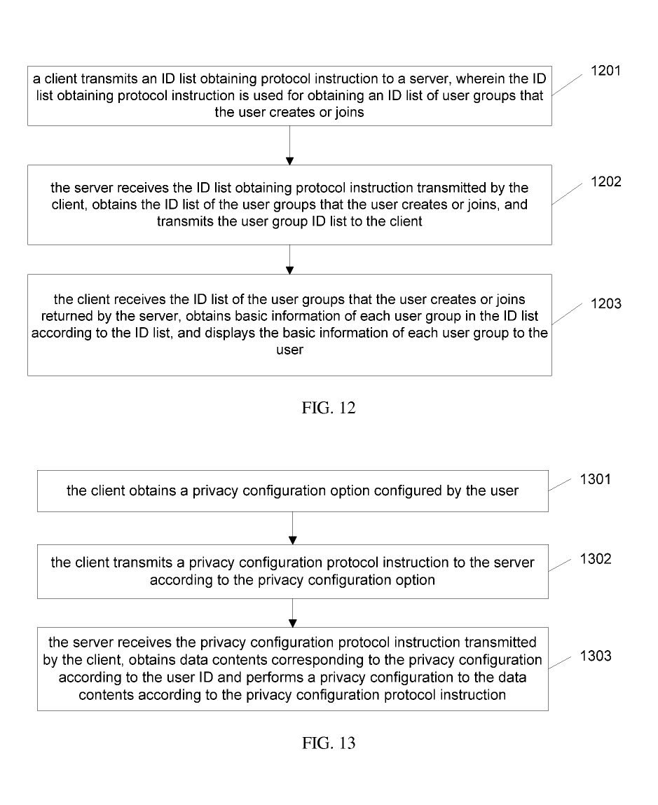

An example of the present disclosure further provides a method for managing a user group. This method mainly describes displaying of information of a user group created by a user or a user joins. With reference to FIG. 12, the method includes the following.

At block 1201, a client transmits an ID list obtaining protocol instruction to a server, wherein the ID list obtaining protocol instruction is used for obtaining an ID list of user groups that the user creates or joins. The ID list obtaining protocol instruction includes a user ID.

The ID list obtaining protocol instruction which is transmitted by the client to the server for obtaining the ID list of the user groups that the user creates or joins may be transmitted to the server automatically when the user logs on the client, or may be transmitted to the server under a trigger of the user after the user logs on the client. The detailed method is not restricted in the present disclosure.

At block 1202, the server receives the ID list obtaining protocol instruction transmitted by the client, obtains the ID list of the user groups that the user creates or joins, and transmits the user group ID list to the client.

It should be noted that, with respect to the creation of each user group, the relevant information of the creation is saved by the server in form of a data table. The relevant information may include a user group name, a user group ID and a creating user, etc. Relevant information of each user may also be saved by the server in form of a data table. When the relevant information of a user is required, the server may obtain the relevant information of the user including the ID of the user group that the user creates or joins through querying the relevant data table according to the user ID.

At block 1203, the client receives the ID list of the user groups that the user creates or joins returned by the server, obtains basic information of each user group in the ID list according to the ID list, and displays the basic information of each user group to the user.

Furthermore, after the user obtains and displays the ID list of the user groups that the user creates or joins, the user may further configure the ID list as visible or invisible to other users via privacy configuration, With reference to FIG. 13. The method includes the following operations.

At block 1301, the client obtains a privacy configuration option configured by the user, wherein the privacy configuration option includes whether displaying the user groups that the user creates or joins to other users or not.

When configuring the privacy configuration option, the user may configure the privacy configuration option via a privacy configuration interface. The privacy configuration option may be presented to the user for selection in form of a unit. The detailed method is not restricted in the present disclosure. In microblogs, the privacy configuration option may include whether to display the user groups that the user creates or joins in personal information or a guest page, which is not restricted in the present disclosure, if only the privacy configuration option includes whether to display the user groups that the user creates or joins to other users or not.

At block 1302, the client transmits a privacy configuration protocol instruction to the server according to the privacy configuration option, wherein the privacy configuration instruction includes the user ID.

At block 1303, the server receives the privacy configuration protocol instruction transmitted by the client, obtains data contents corresponding to the privacy configuration according to the user ID and performs a privacy configuration to the data contents according to the privacy configuration protocol instruction, such that when other users inquires the personal information of the user, a determination on whether to display the user group that the user creates or joins to the other user may be performed according to the privacy configuration.

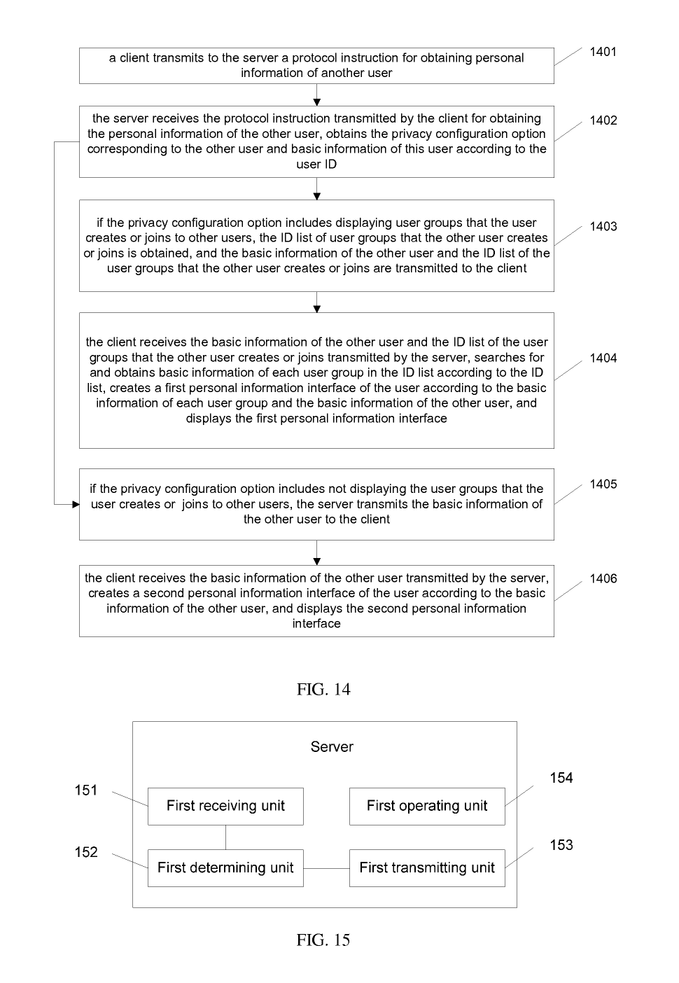

A following optional operation may be further included: the user may review personal information of other users on his client. Based on the description of the blocks 1301 to 1303, when the user reviews of the personal information of another user, different types of personal information may be obtained with respect to different privacy configurations configured by the other users, including personal information containing a list of user groups that the user creates or joins and personal information not containing the list of user groups that the user creates or joins. The details are shown in FIG. 14. The method includes the following operations.

At block 1401, a client transmits to the server a protocol instruction for obtaining personal information of another user, wherein the protocol instruction for obtaining the personal information of another user includes a user ID of the other user, i.e., the user whose personal information is to be obtained; the protocol instruction for obtaining the personal information of another user is a protocol instruction transmitted to the server when the user wants to inquire the personal information of another user except for the user himself.

At block 1402, the server receives the protocol instruction transmitted by the client for obtaining the personal information of the other user, wherein the protocol instruction for obtaining the personal information of the other user includes the user ID of the other user, the server obtains the privacy configuration option corresponding to the other user and basic information of this user according to the user ID.

At block 1403, if the privacy configuration option includes displaying user groups that the user creates or joins to other users, the ID list of user groups that the other user creates or joins is obtained, and the basic information of the other user and the ID list of the user groups that the other user creates or joins are transmitted to the client.

At block 1404, the client receives the basic information of the other user and the ID list of the user groups that the other user creates or joins transmitted by the server, searches for and obtains basic information of each user group in the ID list according to the ID list, creates a first personal information interface of the user according to the basic information of each user group and the basic information of the other user, and displays the first personal information interface to end the obtaining of the personal information of this time.

At block 1405, if the privacy configuration option includes not displaying the user groups that the user creates or joins to other users, the server transmits the basic information of the other user to the client.

At block 1406, the client receives the basic information of the other user transmitted by the server, creates a second personal information interface of the user according to the basic information of the other user, and displays the second personal information interface to end the obtaining of the personal information of the user of this time.

In the example of the present disclosure, the user groups that the user creates or joins may be displayed to the user in the personal information of the user, which facilitates the user to check that the user is added in which user groups. Thus, the user's experience is improved.

In addition, in the example of the present disclosure, after the information of the user group that the user creates or joins is displayed to the user, the user may configure the user group list as visible or invisible to other users through the privacy configuration operation interface, so as to protect the privacy of the user. If the user configures to display the user groups that the user creates or joins to other users, other users can see the user groups related to this user conveniently, which greatly facilitates the extension and creation of the user group.

An example of the present disclosure further provides a server, as shown in FIG. 15. The server includes: a first receiving unit 151, a first determining unit 152, a first transmitting unit 153 and a first operating unit 154.

The first receiving unit 151 is adapted to receive a recommend join protocol instruction recommending a user to join a pre-determined user group transmitted by a client, wherein the recommend join protocol instruction includes an ID of the recommended user and an ID of the pre-determined user group.

The first determining unit 152 is adapted to determine a creating user of the pre-determined user group according to the ID of the pre-determined user group received by the first receiving unit 151.

The first transmitting unit 153 is adapted to transmit a recommend join notification message to the creating user determined by the first determining unit 152, such that the creating user determines whether to add the recommended user to the pre-determined user group.

The first operating unit 154 is adapted to add the ID of the recommended user to a member list of the pre-determined user group if a response message indicating that the creating user agrees to add the recommended user to the pre-determined user group transmitted by the creating user is received.

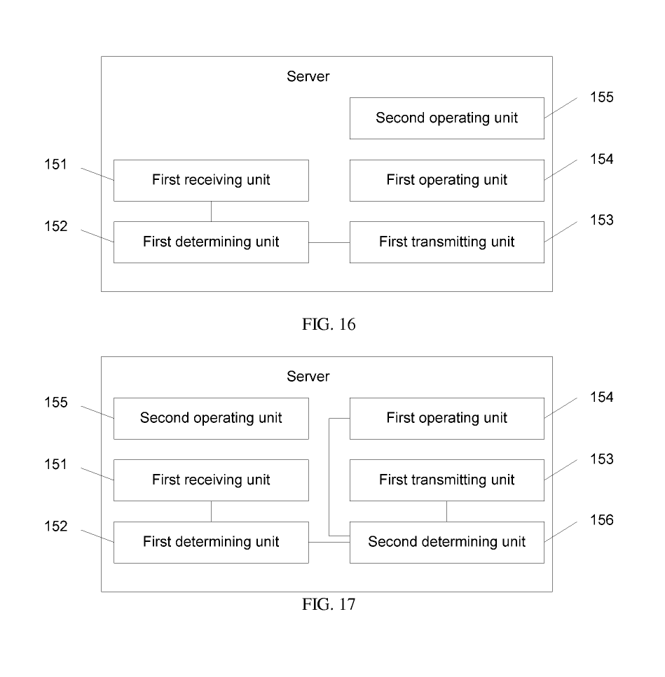

Optional, with reference to FIG. 16, the server may further include a second operating unit 155.

The second operating unit 155 is adapted to not add the ID of the recommended user to the member list of the pre-determined user group if a response message indicating that the creating user does not agree to add the recommended user to the pre-determined user group transmitted by the creating user is received.

Optional, with reference to FIG. 17, the server may further include a second determining unit 156.

If the recommend join protocol instruction includes the ID of the recommending user, the second determining unit 156 is adapted to determine, after the first determining unit 152 determines the creating user of the pre-determined user group according to the ID of the pre-determined user group, whether the creating user of the pre-determined user group is the recommending user according to the ID of the recommending user.

The first operating unit 154 is further adapted to add, if the second determining unit 156 determines that the creating user of the pre-determined user group is the recommending user, the ID of the recommended user to the member list of the pre-determined user group directly.

The first transmitting unit 153 is further adapted to transmit, if the second determining unit 156 determines that the creating user of the pre-determined user group is not the recommending user, the recommend join notification message to the creating user.

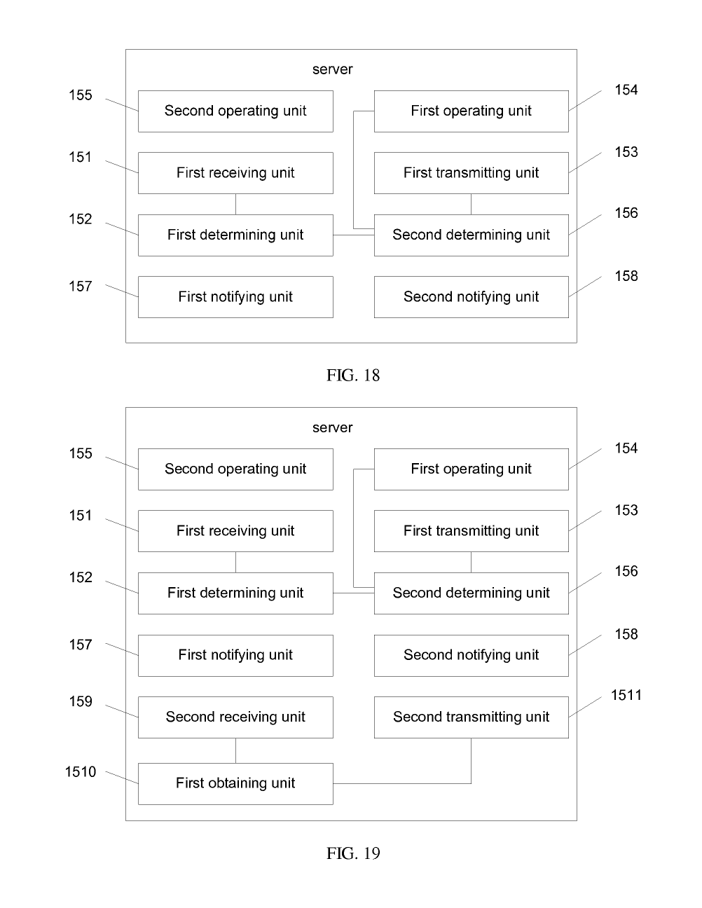

Optional, with reference to FIG. 18, the server may further include a first notifying unit 157 and/or a second notifying unit 158.

The first notifying unit 157 is adapted to transmit a notification message to the recommending user indicating that the recommended user has been added in the pre-determined user group after the first operating unit 154 adds the ID of the recommended user in the member list of the pre-determined user group.

The second notifying unit 158 is adapted to transmit a notification message to the recommended user indicating that the recommended user has been added in the pre-determined user group after the first operating unit 154 adds the ID of the recommended user to the member list of the pre-determined user group.

Optional, with reference to FIG. 19, the server may further include a second receiving unit 159 ad a first obtaining unit 1510 and a second transmitting unit 1511.

The second receiving unit 159 is adapted to receive a ID list obtaining protocol instruction transmitted by the client, wherein the ID list obtaining protocol instruction is used for obtaining the ID list of the user groups that the user creates or joins, the ID list obtaining protocol instruction includes the user ID.

The first obtaining unit 1510 is adapted to obtain the ID list of the user groups that the user creates or joins according to the user ID received by the second receiving unit 159.

The second transmitting unit 1511 is adapted to transmit the ID list obtained by the first obtaining unit 1510 to the client.

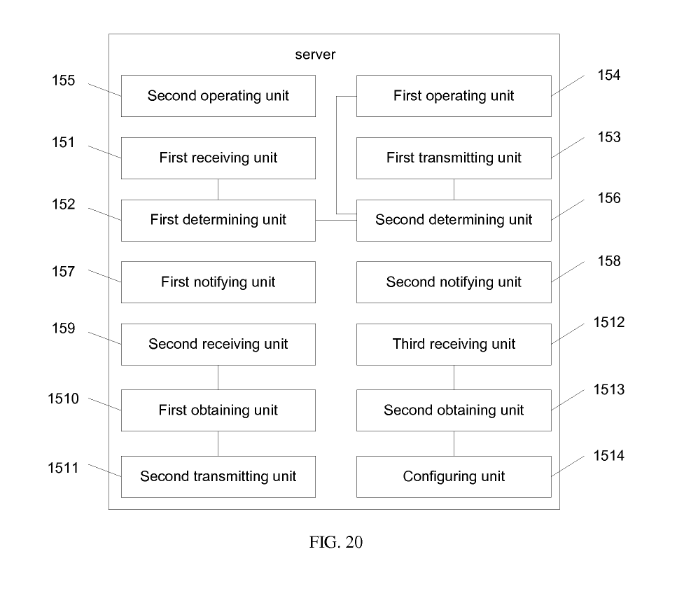

Optional, with reference to FIG. 20, the server may further include a third receiving unit 1512, a second obtaining unit 1513 and a configuring unit 1514.

The third receiving unit 1512 is adapted to receive a privacy configuration protocol instruction transmitted by the client, wherein the privacy configuration protocol instruction includes the user ID. The privacy configuration protocol instruction is a protocol instruction transmitted by the client according to a privacy configuration option configured by the user. The privacy configuration option includes whether to display the user groups that the user creates or joins to other users.

The second obtaining unit 1513 is adapted to obtain data contents corresponding to the privacy configuration according to the user ID received by the third receiving unit 1512.

The configuring unit 1514 is adapted to perform a privacy configuration to the data contents obtained by the second obtaining unit 1513 according to the privacy configuration protocol instruction.

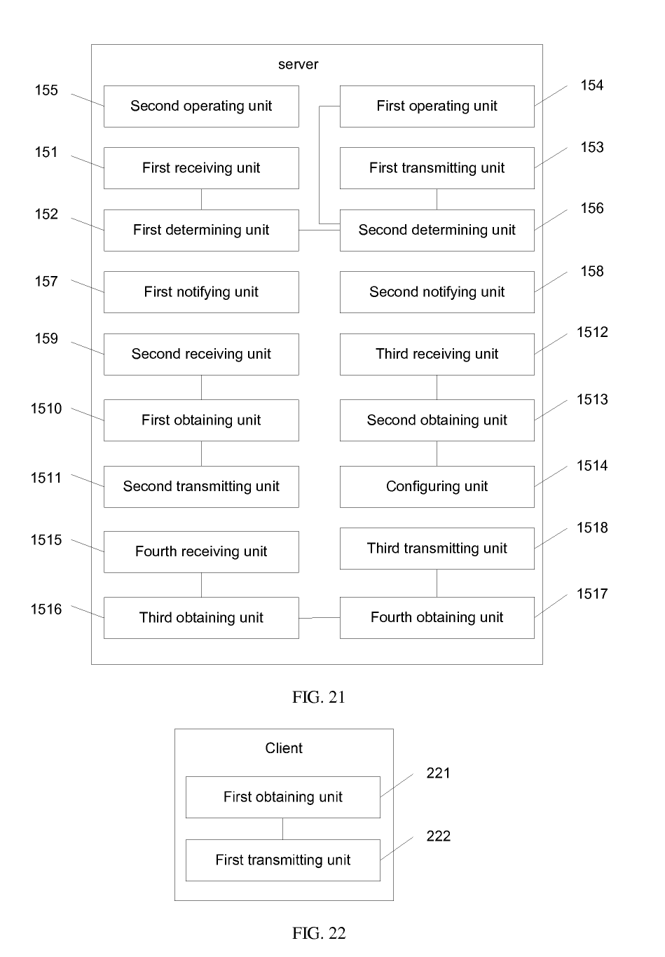

Optional, with reference to FIG. 21, the server may further include: a fourth receiving unit 1515, a third obtaining unit 1516, a fourth obtaining unit 1517 and a third transmitting unit 1518.

The fourth receiving unit 1515 is adapted to receive a protocol instruction for obtaining personal information of another user transmitted by the client, wherein the protocol instruction for obtaining the personal information of the other user includes the user ID of the other user; the protocol instruction for obtaining the personal information of the other user is transmitted to the server when the user inquires the personal information of another user except for the user himself.

The third obtaining unit 1516 is adapted to obtain the privacy configuration option corresponding to the other user and the personal information of the other user according to the user ID received by the fourth receiving unit 1515.

The fourth obtaining unit 1517 is adapted to obtain the ID list of the user groups that the other user creates or joins if the privacy configuration option includes displaying the user groups that the user creates or joins to the other users.

The third transmitting unit 1518 is adapted to transmit the personal information of the other user obtained by the third obtaining unit 1516 and the ID list of the user groups that the other user creates or joins obtained by the fourth obtaining unit 1517 to the client.

The third transmitting unit 1518 is further adapted to transmit the basic information of the other user obtained by the third obtaining unit 1516 to the client if the privacy configuration option includes not displaying the user groups that the user creates or joins to the other users.

It should be noted that, other descriptions of the functional modules included in the server may refer to the corresponding descriptions in the above method for managing user group members and will not be repeated herein.

An example of the present disclosure further provides a client. With reference to FIG. 22, the client includes a first obtaining unit 221 and a first transmitting unit 222.

The first obtaining unit 221 is adapted to obtain an ID of a user being recommended to join a pre-determined user group. The first obtaining unit 221 may obtain the ID of the recommended user inputted by the user, or obtain the ID of the recommended user selected by the user from user groups of the user, which is not restricted by the present disclosure.

The first transmitting unit 222 is adapted to transmit a recommend join protocol instruction recommending the user to join the pre-determined user group to a server, wherein the recommend join protocol instruction includes the ID of the recommended user and the ID of the pre-determined user group.

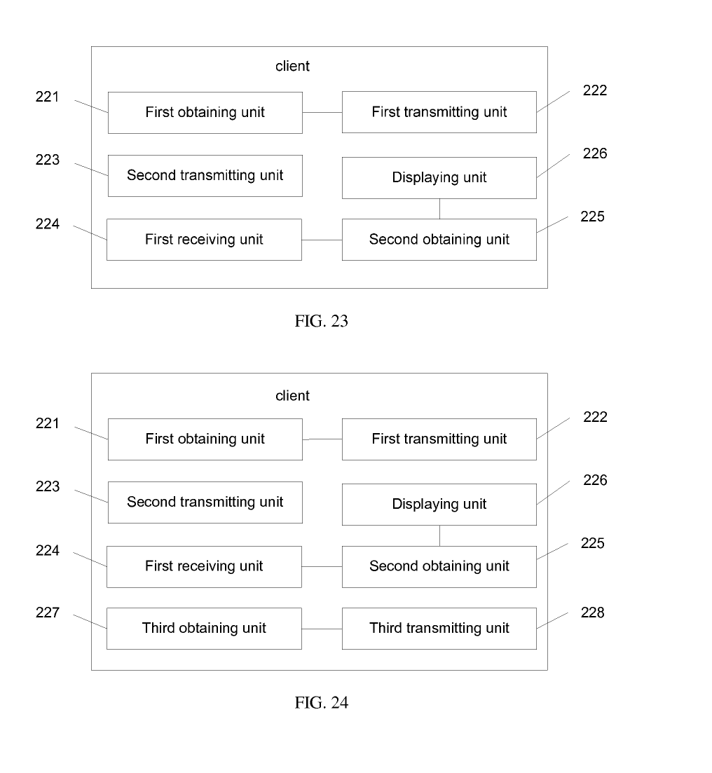

Optional, with reference to FIG. 23, the client may further include a second transmitting unit 223, a first receiving unit 224, a second obtaining unit 225 he a displaying unit 226.

The second transmitting unit 223 is adapted to transmit an ID list obtaining protocol instruction to the server, wherein the ID list obtaining protocol instruction is used for obtaining the ID list of the user groups that the user creates or joins, and the ID list obtaining protocol instruction includes the user ID.

The first receiving unit 224 is adapted to receive the ID list of the user groups that the user creates or joins returned by the server.

The second obtaining unit 225 is adapted to obtain basic information of each user group in the ID list according to the ID list received by the first receiving unit 224.

The displaying unit 226 is adapted to display the basic information of each user group obtained by the second obtaining unit 225.

Optional, with reference to FIG. 24, the client may further include: a third obtaining unit 227 and a third transmitting unit 228.

The third obtaining unit 227 is adapted to obtain, after the displaying unit 226 displays the basic information of each user group, a privacy configuration option of the user, wherein the privacy configuration option includes whether to display the user groups that the user creates or joins to other users.

The third transmitting unit 228 is adapted to transmit a privacy configuration protocol instruction to the server according to the privacy configuration option obtained by the third obtaining unit 227, wherein the privacy configuration protocol instruction includes the user ID.

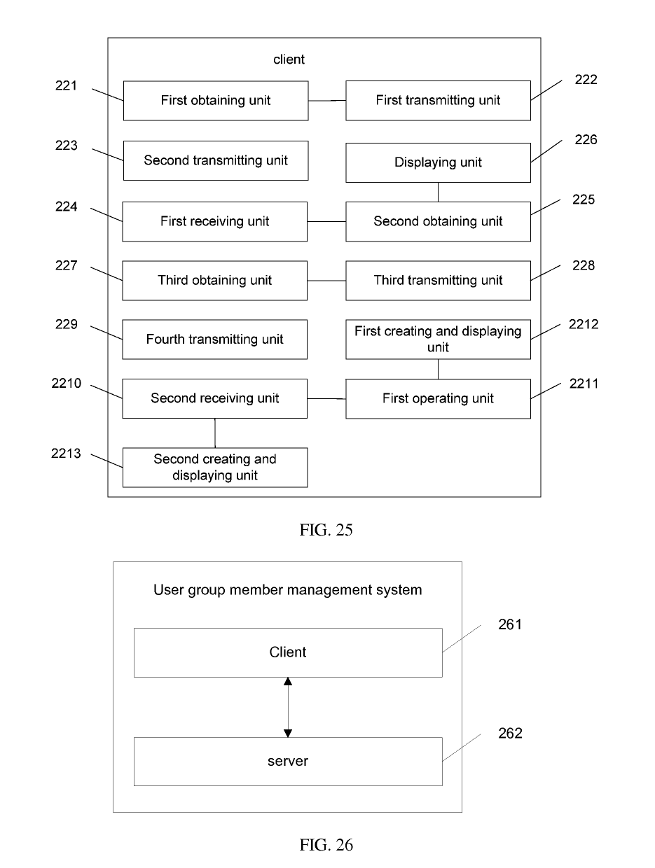

Optional, with reference to FIG. 25, the client may further include: a fourth transmitting unit 229, a second receiving unit 2210, a first operating unit 2211, a first creating and displaying unit 2212 and a second creating and displaying unit 2213.

The fourth transmitting unit 229 is adapted to transmit, when the user wants to view personal information of another user except for the user himself, a protocol instruction for obtaining the personal information of the other user to the server, wherein the protocol instruction for obtaining the personal information of the other users includes the user ID.

The second receiving unit 2210 is adapted to receive the basic information of the user returned by the server, or receive the basic information of the user and the ID list of the user groups that the user creates or joins returned to the client by the server.

The first operating unit 2211 is adapted to search for, when the second receiving unit 2210 receives the basic information of the user and the ID list of the user groups that the user creates or joins and returns them to the client, basic information of each user group in the ID list of the user groups according to the ID list of the user groups.

The first creating and displaying unit 2212 is adapted to create, according to the basic information of the user and the basic information of each user group obtained by the first operating unit 2211, a first personal information interface of the user and display the first personal information interface.

The second creating and displaying unit 2213 is adapted to create, when the second receiving unit 2210 receives the basic information of the user, a second personal information interface of the user according to the basic information of the user and display the second personal information.

It should be noted that, other descriptions of the functional modules included in the client may refer to corresponding descriptions in the above method for managing the user group members in the above examples of the present disclosure. Those will not be repeated herein.

An example of the present disclosure further provides a system for managing user group members. With reference to FIG. 26, the system includes a client 261 and a server 262.

The client 261 is adapted to obtain an ID of a user being recommended to join a pre-determined user group, transmit a recommend join protocol instruction recommending the user to join the pre-determined user group to the server 262, wherein the recommend join protocol instruction includes the ID of the recommended user and the ID of the pre-determined user group.

The server 262 is adapted to receive the recommend join protocol instruction recommending the user to join the pre-determined user group transmitted by the client 261, wherein the recommend join protocol instruction includes the ID of the recommended user and the ID of the pre-determined user group; determine a creating user of the pre-determined user group according to the ID of the pre-determined user group, transmit a recommend join notification message to the creating user, such that the creating user determines whether to add the recommended user to the pre-determined user group; if a response message indicating that the creating user agrees to add the recommended user to the pre-determined user group, add the ID of the recommended user to a member list of the pre-determined user group.

It should be noted that, other descriptions of the functional modules included in the system may refer to corresponding descriptions in the above method for managing the user group members in the above examples of the present disclosure. Those will not be repeated herein.

In the example of the present disclosure, when a user needs to recommend a user in a user group to another user group, the client obtains the ID of the user being recommended to join the pre-determined user group, and transmits a recommend join protocol instruction recommending the user to join the pre-determined user group to the server. After receiving the recommend join protocol instruction, the server determines the creating user of the pre-determined user group according to the ID of the pre-determined user group included in the pre-determined user group and transmits a recommend join notification message to the creating user. If a response message indicating that the creating user agrees to add the recommended user to the pre-determined user group transmitted by the creating user is received, the ID of the recommended user is added to a member list of the pre-determined user group. It is realized to recommend a user to a user group, which facilitates the extension and creation of the user group. Furthermore, when the user recommends the user to join the pre-determined user group, the user may recommend a plurality of users at one time, which avoid transmitting one recommend join protocol instruction each time one user is recommended. Thus, resources are saved and the extension and creation of the user group is facilitated.

In addition, in the example of the present disclosure, if the creating user of the pre-determined user group is the recommending user, the ID of the recommended user is directly added in the member list of the pre-determined user group, which omits the acknowledgement of the creating user of the pre-determined user group and accelerates the join procedure of the recommended user.

Furthermore, after the ID of the recommended user is added to the member list of the pre-determined user group, an example of the present disclosure may further transmit a notification message to the recommending user notifying the recommending user that the recommended user has been added in the pre-determined user group, so as to facilitate the recommending user to acquire the join status of the recommended user. Or, a notifying message notifying the recommended user that he has been added in the pre-determined user group may be transmitted to the recommended user, such that the recommended user may know the user group that he joins, which improves user's experience.

In various examples of the present disclosure, the user groups that the user creates or joins may be displayed to the user in the user personal information, so as to facilitate the user to check he has been added in which user groups and to improve user's experience.

In addition, in the example of the present disclosure, after the information of the user groups that the user creates or joins is displayed to the user, the user may configure through a privacy configuration operating interface the user group list as visible or invisible to other users, so as to protect the privacy of the user. If the user configures to display the user groups that the user creates or joins in the personal information or a guest page to other users, other users may see the user groups related to this user conveniently, which greatly facilitates the extension and creation of user groups for the user.

It should be noted that, the user group in the method, apparatus and system for managing user group members may be a microblog list in microblog or a group in other IM tools, which is not restricted in the present disclosure.

A microblog list (group) is a platform for microblog users having similar hobbies or same labels to focus on and communicate with each other within a friend connection. When a user creates or joins a microblog group, the user may chat with a plurality of users in the microblog group. In a conventional microblog system, the user can have a group chat only after joining the microblog group. A one to more chat function that a microblog user outside of the microblog group chats with users in the microblog group cannot be realized. The user's experience is lowered and the compatibility of the product is lowered.

Therefore, various examples of the present disclosure further provide a method, a microblog terminal and a microblog server for distributing a microblog message.

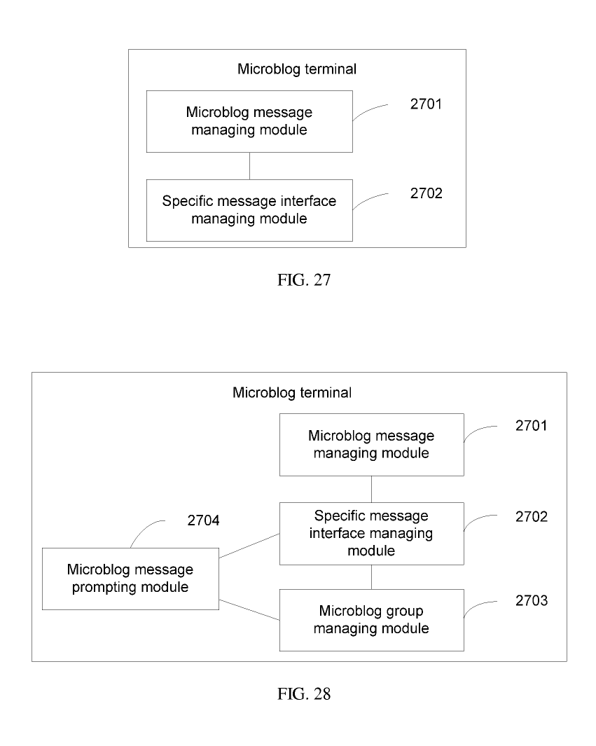

FIG. 27 is a schematic diagram illustrating a first structure of a microblog terminal according to an example of the present disclosure. With reference to FIG. 27, the microblog terminal includes: a microblog message managing module 2701 and a special message interface managing module 2702.

The microblog message managing module 2701 is adapted to manage a microblog message, when a user is to distribute a microblog message, obtain the microblog message to be distributed, and transmit the microblog message to the microblog server.

In a practical application, the user logs on the microblog server using a registered account and password for authentication via an IM client of the microblog terminal. If the authentication succeeds, a tunnel is established between the microblog terminal and the microblog server. The microblog terminal accesses the microblog server via an access server. The microblog terminal transmitted heartbeat packets to the microblog server periodically to maintain the connection with the microblog server. The microblog terminal may display a broadcast message interface such as a microblog homepage, hot broadcast, broadcast lobby or same-city broadcast, a user-specific message interface (e.g., @ message interface), a group message interface and a private message interface. The microblog message managing module 2701 manages the microblog messages of the user. When the user's mouse clicks a broadcast button, the microblog message managing module 2701 responses to the mouse operation of the user and creates a broadcast window for the user. When the user inputs a microblog message in the broadcast window, the microblog message managing module 2701 monitors the input key information of the user in real-time. If it is monitored that the user's mouse clicks a distribution button, the microblog message managing module 2701 obtains the microblog message to be distributed in the broadcast window according to the monitored input key information and transmits the microblog message to the microblog server. It should be understood that, the microblog message managing module 2701 performs a series of operations such as encapsulation and encryption to the microblog message obtained based on a broadcast distribution protocol before transmitting the microblog message to the microblog server.

It should be noted that, a specific message queue in the example of the present disclosure is a queue used for storing microblog messages including a specific area which includes account information. Preferably, the specific message queue may be a @ message queue. The microblog message in the @ message queue includes: a microblog message including account information, also referred to as: “@ message”, “message about me” or “message mentioned me”. Without special descriptions, the specific message queue in the following examples of the present disclosure is the @ message queue.

In a practical application, the microblog message managing module 2701 is further adapted to obtain, when the user of the microblog terminal returns or forwards a microblog message in the @ message queue as a member of a microblog group, contents returned or forwarded by the user, encapsulate the account information of the microblog group and the contents returned or forwarded by the user to generate a response message or a forward message and transmit it to the microblog server side.

The special message interface managing module 2702 is adapted to receive the microblog message in the specific message queue of the user transmitted by the microblog server side, and display the microblog message in the specific message queue of the user on a specific message interface.

In a practical application, the specific message interface managing module 2702 is preferably a @ interface managing module of the microblog terminal, adapted to manage the @ message interface of the user. It can receive or retrieve the microblog message in the @ message queue of the user pushed by the microblog server side, and display all of the microblog messages in the @ message queue via the @ message interface.

The example of the present disclosure realizes one-to-more dialog between the user outside of the microblog group and the users inside the microblog group. It facilitates microblog users to transmit information and improves user's experience.

FIG. 28 is a schematic diagram illustrating a second structure of a microblog terminal according to an example of the present disclosure. With reference to FIG. 28, similar to the above example, the microblog terminal includes: a microblog message managing module 2701 and a specific message interface managing module 2702. In this example, the microblog terminal further includes: a microblog group (list) managing module 2703 and a microblog message prompting module 2704.

The microblog group managing module 2703 is adapted to manage a microblog group, receive a microblog message in a broadcast queue of the microblog group transmitted by the microblog server, and display the microblog message in the broadcast queue of the microblog group in a group message page.

The microblog group managing module 2703 is mainly used for managing the creation of the microblog group and for managing the basic information and the message interface of the microblog group. In this example, the microblog group managing module 2703 receives or retrieves the microblog message in the broadcast queue of the microblog group pushed by the microblog server and displays the microblog message in the broadcast queue of the microblog group in the group message page.

The microblog message prompting module 2704 is adapted to provide a displaying prompt and a review link for the microblog message in the @ message queue and/or the microblog message in the broadcast queue of the microblog group, and notify the specific message managing module 2702 and/or the microblog group managing module 2703 to display the corresponding microblog message when the user operates the review link.

In a practical application, the microblog message prompting module 2704 is mainly used for prompting the user to check a new microblog message about the user when the new microblog message is distributed. For example, if there is a response message about the user, the link of the response message is provided to the user and the user is prompted to review the link. In this example, the microblog message prompting module 2704 provides a displaying prompt and a review link for the microblog message in the @ message queue of the user and/or a displaying prompt and a review link for the microblog message in the broadcast queue of the microblog group. When the user operates the review link (e.g., click the review link), the specific message interface managing module 2702 and/or the microblog group managing module 2703 is notified to display the corresponding microblog message in the @ message interface and/or the group message interface.

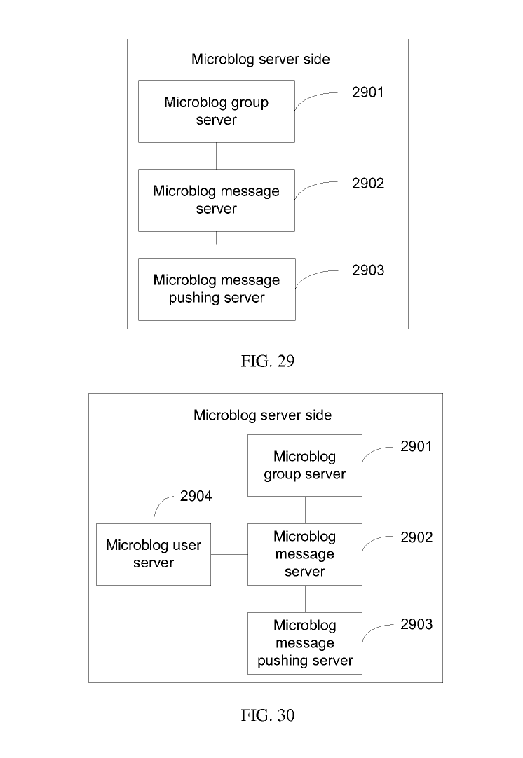

FIG. 29 is a schematic diagram illustrating a first structure of a microblog server side according to an example of the present disclosure. With reference to FIG. 29, the microblog server side includes: a microblog group server 2901, a microblog message server 2902 and a microblog message pushing server 2903.

The microblog group server 2901 is adapted to store and manage basic information of a microblog group.

Generally, the basic information of the microblog group includes but is not limited to: group account information, member account information group, group type and group label attribute. The microblog group server 2901 interacts with the microblog group managing module 2703 of the microblog terminal to provide various services such as creation and management of the microblog group and management of the basic information and the group message interface. The interaction procedure is similar to those in the related art and will not be repeated herein.

The microblog message server 2902 is adapted to determine whether a microblog message transmitted by a first microblog terminal contains microblog group account information in a specific area, if yes, add the microblog message to the specific message queue of each member of the microblog group.

In a practical application, the specific area of the microblog message is a pre-determined area arranged for a pre-defined regular expression. The microblog server side arrange the regular expression of the microblog message with the microblog terminal in advance, e.g., @+account information+space+message contents. The specific area of the regular expression may be an area ahead of the message contents. After receiving the microblog message transmitted by the microblog terminal, the microblog message server 2902 firstly checks whether the microblog message is complete, i.e., checks whether the microblog message has a complete message structure (a structure including a message header and a message body, etc.). If it is determined that the microblog message is incomplete, the microblog message is determined as invalid. The microblog message server 2902 discards the microblog message. If it is determined that the microblog message is complete, the microblog message is determined as valid. The microblog message server 2902 compares the microblog message based on a regular matching rule according to the pre-determined regular expression. If the format of the microblog message does not match the above regular expression, the matching fails. The microblog message server 2902 treats the microblog message as a traditional broadcast message. The procedure is similar to a broadcasting procedure of the microblog message in the related art and will not be repeated herein. If the format of the microblog message matches the above regular expression, the matching succeeds. The microblog message server 2902 determines the portion before the message contents of the microblog message as the specific area of the microblog message and retrieves account information (contents between “@” and “space”) from the specific area of the microblog message. It is determined whether the account information is the microblog group account information in the microblog group server 2901. If the account information is the microblog group account information, the microblog message server 2902 adds the microblog message to the @ message queue of each member of the microblog group. It should be understood that, the above regular expression is merely an example. The function of “@” and “space” in the expression is to set the account information and the message contents apart. Obviously, the regular expression may be determined according to a practical requirement, e.g., letter+account information+space+message contents, or message contents+letter+account information+space, or message contents+@+account information+space+message contents, etc. The above situations may be implemented similarly as described above and will not be repeated herein.

When the member of the microblog group responses to or forwards the microblog message distributed by the first user in the @ message queue of the member, the microblog message server 2902 is further adapted to receive the response message or forward message transmitted by the microblog terminal corresponding to the member, add the response message or forward message to the broadcast queue of the microblog group according to the microblog group account information in the response message or forward message, and notifies a microblog message pushing server 2903 to push the microblog message in the broadcast queue of the microblog group to the first microblog terminal for distribution. In a practical application, when the microblog message pushing server 2903 pushes the microblog message in the broadcast queue of the microblog group to the first microblog terminal for distribution, it also pushes the microblog message to microblog terminals corresponding to all of the users listening to the microblog group, such that all of the users listening to the microblog group may review the microblog message in the broadcast queue of the microblog group.

The microblog message pushing server 2903 is adapted to scan the specific message queue of each member of the microblog group after the adding operation of the microblog message server 2902, push, for each member of the microblog group, the microblog message in the specific message queue of the member of the microblog group to the microblog terminal corresponding to the member of the microblog group for distribution.

In a practical application, the microblog message pushing server 2903 is mainly used for forwarding various kinds of microblog messages or relevant data packets that each user forwarded to other users or microblog group via the microblog terminal. It may scan the message queue of each user in real-time or periodically. In the case that there is a new microblog message in the message queue, it pushes the microblog message in the message queue to each user. In this example, after the microblog message pushing server 2903 pushes the microblog message in the @ message queue of each member in the microblog group to the microblog terminal corresponding to the member, the microblog terminal corresponding to each member in the microblog group provides a display prompt and a review link for the microblog message in the @ message queue for the member in the microblog group. When the member in the microblog group operates the review link, the microblog terminal corresponding to the member in the microblog group displays the microblog message in the @ message queue of the member in the microblog group on the @ message interface.

According to the microblog server side and the microblog terminal provided by the examples of the present disclosure, the one-to-more dialog between a user outside the microblog group and the users inside the microblog group is realized. And a more-to-one dialog between users inside the microblog group and the user outside the microblog group is also realized. The user's experience is improved and the compatibility of the product is improved.

FIG. 30 is a schematic diagram illustrating a second structure of a microblog server side according to an example of the present disclosure. With reference to FIG. 30, similar to the above example, the microblog server side includes: a microblog group server 2901, a microblog message server 2902 and a microblog message pushing server 2903. In this example, the microblog server side further includes: a microblog user server 2904.

The microblog user server 2904 is adapted to store and manage basic information of the microblog user.

Generally, the basic information of the microblog user includes but is not limited to: user account information, user type, user label attribute and authentication information. In the above example, if the microblog group server 2901 determines that the account information included in the specific area of the microblog message is not the microblog group account information, it further query the microblog user server 2904 to determine whether the account information is the account information of a user. If yes, the microblog message server 2902 adds the microblog message to the @ message queue of the user according to the user account information queried by the microblog message server 2902 and notifies the microblog message pushing server 2903 to push the microblog message in the @ message queue of the user to the microblog terminal of the user for distribution. The microblog terminal of the user obtained by querying displays the microblog message in the @ message queue on the @ message interface. It should be noted that, the procedure of transmitting a microblog message to a single microblog user is similar to the procedure of transmitting a private message to a single microblog user in the related art and will be not be repeated herein.

It should be understood that, if the microblog group server 2901 determines that the account information in the microblog message is neither the microblog group account information nor the account information of a single user, it indicates that the specific area of the microblog message includes neither the microblog group account information nor the account information of a single user. Thus, the microblog message is treated as a traditional broadcast message. The procedure is similar to the broadcasting procedure of the microblog message in the related art and will not be repeated herein.

In order to make the present disclosure clearer, the microblog message server 2902 at the microblog server side will be described in further detail hereinafter.

FIG. 31 is a schematic diagram illustrating a structure of a microblog message server according to an example of the present disclosure. With reference to FIG. 31, the microblog message server 2902 includes: a parsing unit 2921, a detecting unit 2922, a first operating unit 2923, a determining unit 2924 and a second operating unit 2925.

The parsing unit 2921 is adapted to parse a microblog message transmitted by a microblog terminal according to a regular matching principle and determine a specific area of the microblog message which matches the pre-determined area arranged for a pre-defined regular expression.

In a practical application, the microblog server side may arrange the regular expression with the microblog terminal in advance, e.g., @+account information+space+message contents. The specific area defined by this regular expression is the area before the message contents. After receiving the microblog message transmitted by the microblog terminal, the parsing unit 2921 firstly checks whether the microblog message is complete, i.e., checks whether the microblog message has a complete message structure (a structure having a message header, a message body, etc.). If the microblog message is incomplete, the microblog message is determines as invalid. The parsing unit 2921 discards the microblog message. If the microblog message is complete, the microblog message is determined as valid. The parsing unit 2921 compares the microblog message based on the regular matching principle according to the pre-defined regular expression. If the format of the microblog message does not match the above regular expression, the matching fails. The parsing unit 2921 treats the microblog message as a traditional broadcast message. The procedure is similar to the broadcasting procedure of the microblog message and will not be repeated herein. If the format of the microblog message matches the above regular expression, the matching succeeds. The parsing unit 2921 determines the portion before the message contents of the microblog message as the specific area of the microblog message.

It should be understood that, since the microblog terminal performs a series of operations such as encapsulation and encryption to the microblog message based on the broadcast distribution protocol, the parsing unit 2921 needs to perform a corresponding series of operations such as decapsulation and decryption to the microblog message before the parsing operation. The operations are similar to those in the related art and will be not repeated herein.

The detecting unit 2922 is adapted to determine whether the specific area of the microblog message contains microblog group account information according to the specific area of the microblog message determined by the parsing unit 2921.

In a practical application, the detecting unit 2922 retrieves account information (contents between “@” and “space”) from the specific area of the microblog message according to the specific area of the microblog message determined by the parsing unit 2921, determines in association with the microblog group server 2901 whether the account information is the microblog group account information.

The first operating unit 2923 is adapted to search the microblog group server 2901 for a member account information group if the detecting unit 2922 determines that the account information is the microblog group account information, and add the microblog message to a specific message queue (@ message queue) of each member of the microblog group according to the member account information group.

The determining unit 2924 is adapted to determine whether the specific area of the microblog message contains account information of a second user if the detecting unit 2922 determines that the account information is not the microblog group account information.

In a practical application, if the detecting unit 2022 determines that the account information is not the microblog group account information, the determining unit 2924 further queries the microblog user server 2904 to determine whether the account information is account information of a single user.

The second operating unit 2925 is adapted to add the microblog message to a specific message queue (@ message queue) of the second user according to the account information of the second user if the determining unit 2924 determines that the account information is of the second user, and notify the microblog message pushing server to push the microblog message in the specific message queue of the second user to the second microblog terminal corresponding to the second user for distribution. It should be understood that, if the determining unit 2924 determines that the account information is not the account information of the second user, it indicates that the specific area of the microblog message includes neither the microblog group account information nor account information of a single user. The microblog message is treated as a traditional broadcast message. The procedure is similar to the broadcasting procedure of the microblog message in the related art and will not be repeated herein.

It should be noted that, in the example of the present disclosure, the first user is any microblog user in the microblog system, and the second user is any microblog user except for the first user in the microblog system.

The example of the present disclosure realizes the one-to-more dialog between a user outside the microblog group and the users inside the microblog group, and also realizes a more-to-one dialog between users inside the microblog group and the user outside the microblog group. The user's experience is improved and the compatibility of the product is improved.

In order to make the present disclosure clearer, the method for distributing a microblog message of the present disclosure will be described in further detail hereinafter.

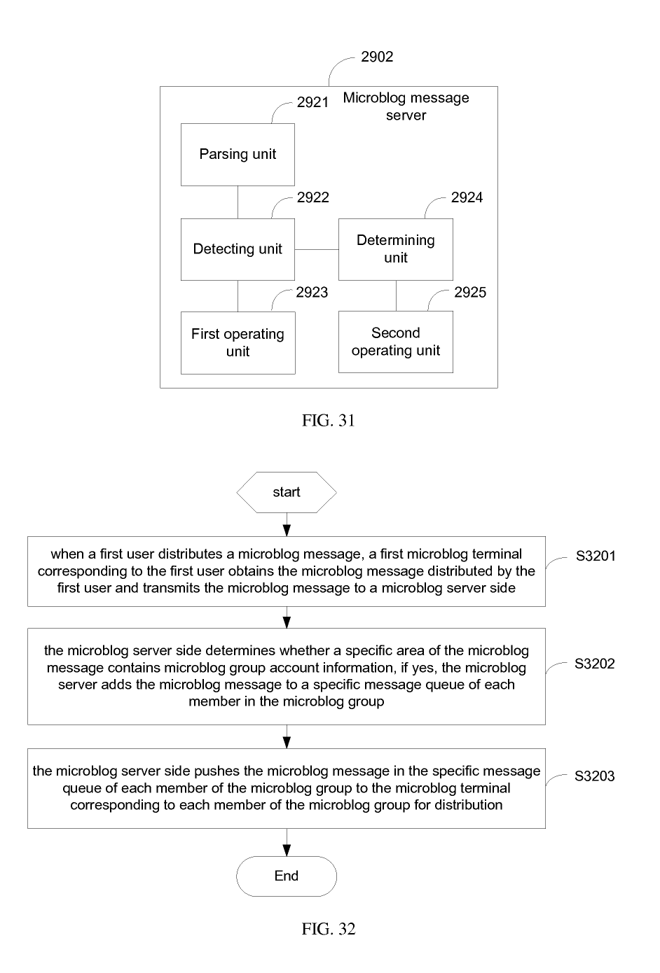

FIG. 32 is a flowchart illustrating a first method for distributing a microblog message according to an example of the present disclosure. With reference to FIG. 32, the method includes the following operations.

At block S3201, when a first user distributes a microblog message, a first microblog terminal corresponding to the first user obtains the microblog message distributed by the first user and transmits the microblog message to a microblog server side.

In a practical application, the user logs on the microblog server side for authentication using a registered user account and password through an IM client of the microblog terminal. If the authentication succeeds, a tunnel is established between the microblog terminal and the microblog server side. The microblog terminal accesses the microblog server side through an access server. The microblog terminal transmits heartbeat packets periodically to the microblog server side to maintain the connection with the microblog server side. The microblog terminal may display a broadcast message interface such as a microblog homepage, a hot broadcast, a broadcast lobby or a co-city broadcast, a @ message interface of the user, a group message interface, a private message interface, etc. The microblog terminal manages the microblog messages of the user. The microblog terminal monitors mouse operations of the user in real-time. If it is monitored that the user's mouse clicks a broadcast button, the microblog terminal responses to the mouse operation of the user and executes block S3201 to create a broadcast window for the user. If the user inputs a microblog message in the broadcast window, the input key information of the user is monitored in real-time in block S3201. If it is monitored that the user's mouse clicks a distribution button, the microblog message to be distributed in the broadcast window is obtained in block S3201 according to the input key information monitored and the microblog message is transmitted to the microblog server side. It should be understood that, in the block S3201, the microblog terminal performs a series of operations such as encapsulation and encryption to the microblog message based on the broadcast distribution protocol before transmitting it to the microblog server side. In this example, the processing procedure to the microblog message in block S3201 is similar to those in the related art and will not be repeated herein.

At block S3202, the microblog server side determines whether a specific area of the microblog message contains microblog group account information, if yes, the microblog server adds the microblog message to a specific message queue (@ message queue) of each member in the microblog group.

In a practical application, the microblog server side may arrange with the microblog terminal a regular expression of the microblog message in advance, e.g., @+account information+space+message contents. The specific area arranged for this regular expression is the area before the message contents. After the microblog server side receives the microblog message transmitted by the microblog terminal, the microblog server side determines whether the microblog message is complete first, i.e., determines whether the microblog message has a complete message structure (such as a message header and a message body). If the microblog message is incomplete, the microblog message is determined as invalid. The server discards the microblog message. If the microblog message is complete, the microblog message is determined as valid. The microblog server side executes block S3202 to compare the microblog message based on the regular matching principle according to the predefined regular expression. If the format of the microblog message does not match the above regular expression, the matching fails. The microblog server side treats the microblog message as a traditional broadcast message. The processing procedure is similar to a broadcasting procedure of the microblog message in the related art and will not be repeated herein. If the format of the microblog message matches the above regular expression, the matching succeeds. The portion before the message contents of the microblog message is determined as the specific area of the microblog message in block S3202. Account information (contents between “@” and “space”) is retrieved from the specific area of the microblog message. It is determined whether the account information is the microblog group account information. If yes, the microblog message is added to the @ message queue of each member of the microblog group in block S3202. It should be noted that, the above regular expression is merely an example. The expression may be determined according a practical requirement, e.g., letter+account information+space+message contents, or message contents+letter+account information+space, or message contents+@+account information+space+message contents, etc. The above situations may be treated similarly as described above and will not be repeated herein.

At block S3203, the microblog server side pushes the microblog message in the specific message queue of each member of the microblog group to the microblog terminal corresponding to each member of the microblog group for distribution.

In a practical application, after the microblog message in the @ message queue of each member in the microblog group is pushed to the microblog terminal corresponding to the each member in block S3203, the microblog terminal corresponding to each member of the microblog group provides a displaying prompt and a review link for the microblog message in the @ message queue of the member in the microblog group. When the member of the microblog group performs a review operation to the review link, the microblog terminal corresponding to the member of the microblog group displays the microblog message in the @ message queue of the member of the microblog group on the @ message interface.

The example of the present disclosure realizes the one-to-more dialog between a user outside the microblog group and the users inside the microblog group, and also realizes a more-to-one dialog between users inside the microblog group and the user outside the microblog group. The user's experience is improved and the compatibility of the product is improved.

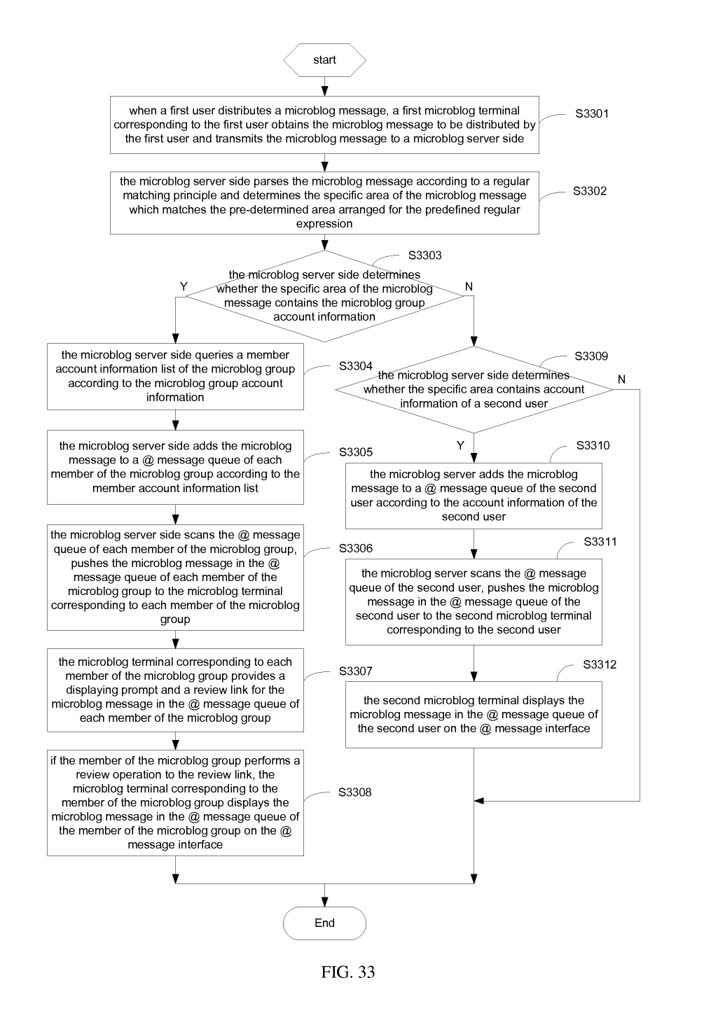

FIG. 33 is a flowchart illustrating a second method for distributing a microblog message according an example of the present disclosure. With reference to FIG. 33, the method includes the following operations.

At block S3301, when a first user distributes a microblog message, a first microblog terminal corresponding to the first user obtains the microblog message to be distributed by the first user and transmits the microblog message to a microblog server side.

In this example, blocks S3301 is the same as S3201 in the above example and will not be described again.

At block S3202, the microblog server side parses the microblog message according to a regular matching principle and determines the specific area of the microblog message which matches the pre-determined area arranged for the predefined regular expression.

In a practical application, the microblog server side may arrange with the microblog terminal a regular expression of the microblog message in advance, e.g., @+account information+space+message contents. The specific area defined by this regular expression is the area before the message contents. After the microblog server side receives the microblog message transmitted by the microblog terminal, the microblog server side determines whether the microblog message is complete first, i.e., determines whether the microblog message has a complete message structure (such as a message header and a message body). If the microblog message is incomplete, the microblog message is determined as invalid. The microblog server side discards the microblog message. If the microblog message is complete, the microblog message is determined as valid. The microblog server side executes block S3302 to compare the microblog message based on the regular matching principle according to the predefined regular expression. If the format of the microblog message does not match the above regular expression, the matching fails. The microblog server side treats the microblog message as a traditional broadcast message. The processing procedure is similar to a broadcasting procedure of the microblog message in the related art and will not be repeated herein. If the format of the microblog message matches the above regular expression, the matching succeeds. The portion before the message contents of the microblog message is determined as the specific area of the microblog message in block S3302.

At block S3303, the microblog server side determines whether the specific area of the microblog message contains the microblog group account information, if yes, block S3304 is performed; otherwise, block S3309 is performed.

In a practical application, account information (contents between “@” and “space”) is retrieved from the specific area of the microblog message. It is determined in the microblog group server at the microblog server side whether the specific area contains the microblog group account information.

At block S3304, the microblog server side queries a member account information group of the microblog group according to the microblog group account information.

At block S3305, the microblog server side adds the microblog message to a @ message queue of each member of the microblog group according to the member account information group.

At block S3306, the microblog server side scans the @ message queue of each member of the microblog group, pushes the microblog message in the @ message queue of each member of the microblog group to the microblog terminal corresponding to each member of the microblog group.

At block S3307, the microblog terminal corresponding to each member of the microblog group provides a displaying prompt and a review link for the microblog message in the @ message queue of each member of the microblog group.

At block S3308, if the member of the microblog group performs a review operation to the review link, the microblog terminal corresponding to the member of the microblog group displays the microblog message in the @ message queue of the member of the microblog group on the @ message interface, then the method ends.

In this example, blocks S3306-S3308 are detailed descriptions of block S3203 in the above example.

At block S3309, the microblog server side determines whether the specific area contains account information of a second user. If yes, block S3310 is performed; otherwise, the method ends.

In a practical application, if it is determined that the specific area does not contain the microblog group account information in block S3303, the microblog server side executes block S3309 to further query the microblog user server at the microblog server side to determine whether the account information is account information of a single user.

At block S3310, the microblog server adds the microblog message to a @ message queue of the second user according to the account information of the second user.

At block S3311, the microblog server scans the @ message queue of the second user, pushes the microblog message in the @ message queue of the second user to the second microblog terminal corresponding to the second user.

At block S3312, the second microblog terminal displays the microblog message in the @ message queue of the second user on the @ message interface, then the method ends.

It should be noted that, in the example of the present disclosure, the first user may be any microblog user in the microblog system, the second user may be any microblog user except for the first user. It should also be understood that, if the determined result of block S3309 is no, it indicates that the specific area of the microblog message contains neither the microblog group account information nor account information of any single user. The microblog message is treated as a traditional broadcast message. The processing procedure is similar to the broadcasting procedure in the related art and will not be repeated herein.

In this example, blocks S3302-S3305, S3309-S3312 are detailed descriptions of block S3302 in the above example.

The example of the present disclosure realizes the one-to-more dialog between a user outside the microblog group and the users inside the microblog group, and also realizes a more-to-one dialog between users inside the microblog group and the user outside the microblog group. The user's experience is improved and the compatibility of the product is improved.

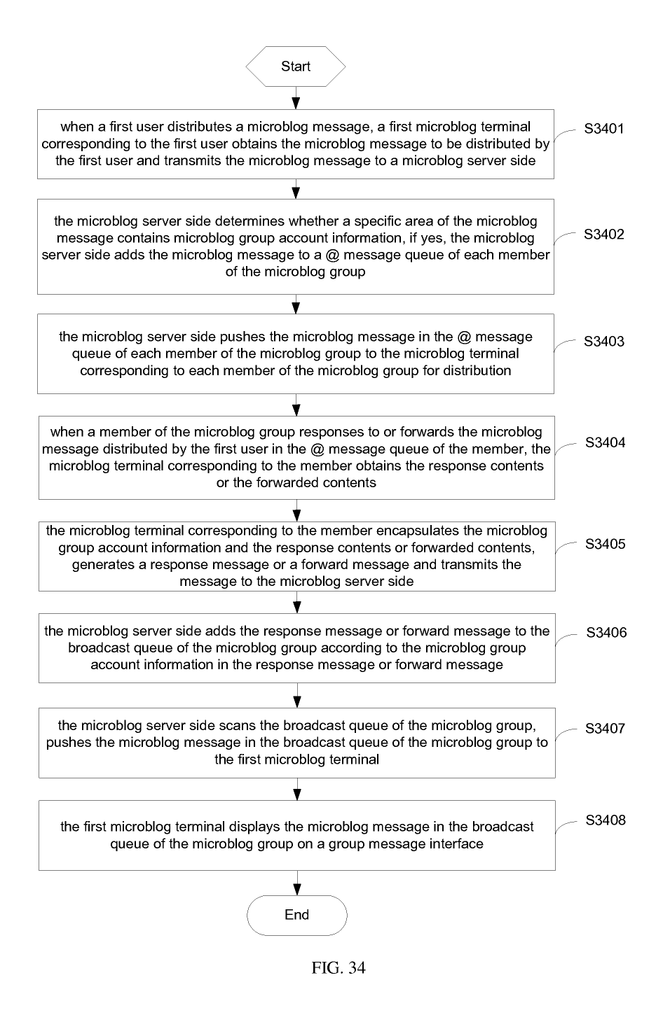

FIG. 34 is a flowchart illustrating a third method for distributing a microblog message according to an example of the present disclosure. With reference to FIG. 34, the method includes the following operations.

At block S3401, when a first user distributes a microblog message, a first microblog terminal corresponding to the first user obtains the microblog message to be distributed by the first user and transmits the microblog message to a microblog server side.

At block S3402, the microblog server side determines whether a specific area of the microblog message contains microblog group account information, if yes, the microblog server side adds the microblog message to a @ message queue of each member of the microblog group.

At block S3403, the microblog server side pushes the microblog message in the @ message queue of each member of the microblog group to the microblog terminal corresponding to each member of the microblog group for distribution.

In this example, blocks S3401-S3403 are similar to blocks S3201-S3203 in the example with reference to FIG. 32 and will not be repeated herein.

At block S3404, when a member of the microblog group responses to or forwards the microblog message distributed by the first user in the @ message queue of the member, the microblog terminal corresponding to the member obtains the response contents or the forwarded contents.

At block S3405, the microblog terminal corresponding to the member encapsulates the microblog group account information and the response contents or forwarded contents, generates a response message or a forward message and transmits the message to the microblog server side.

In a practical application, block S3405 is similar to a microblog message response or forwarding procedure in the related art. Firstly, the account information of a message source being responded to or forwarded is obtained, and then contents responded to by the user or forwarded by the user are obtained. The obtained account information and the responded contents or forwarded contents are encapsulated to generate the final response message or forward message.

At block S3406, the microblog server side adds the response message or forward message to the broadcast queue of the microblog group according to the microblog group account information in the response message or forward message.

At block S3407, the microblog server side scans the broadcast queue of the microblog group, pushes the microblog message in the broadcast queue of the microblog group to the first microblog terminal.

In a practical application, when executing block S3407, the microblog server side also pushes the microblog message to the microblog terminals of all of the users listening to the microblog group, such that all of the users listening to the microblog group can see the microblog message in the broadcast queue of the microblog group.

At block S3408, the first microblog terminal displays the microblog message in the broadcast queue of the microblog group on a group message interface.

In blocks S3404-S3408 of this example, the member of the microblog group responses to or forwards the microblog message in form of a microblog group message, which realizes a more-to-one broadcasting between microblog group and a single microblog user.

The example of the present disclosure realizes the one-to-more dialog between a user outside the microblog group and the users inside the microblog group, and also realizes a more-to-one dialog between users inside the microblog group and the user outside the microblog group. The user's experience is improved and the compatibility of the product is improved.

According to the description of the above example, in the example of the present disclosure, a user may input microblog group account information in the microblog message to be distributed. The microblog server side detects the microblog message to be distributed. If it is detected that the specific area of the microblog message contains the microblog group account information, the microblog message is added to the specific message queue (e.g., @ message queue) of each member of the microblog group. The microblog message in the specific message queue of each member of the microblog group is pushes to the microblog terminal corresponding to each member of the microblog group for distribution, which realizes the one-to-more dialog between a single user (user inside the microblog group or outside the microblog group) and each member of the microblog group, improves user's experience and makes the product more competitive. In addition, each member in the microblog group may response to or forward the received microblog message in the specific message queue. The microblog terminal corresponding to each member encapsulates the microblog group account information and the response contents or forward contents to generate a response message or a forward message and transmits the message to the microblog server side. The microblog server side adds the response message or the forward message to the broadcast queue of the microblog group according to the microblog group account information and pushes to the transmitter (the single microblog user), which realizes the more-to-one dialog between the microblog group to the single microblog user (user inside the microblog group or outside of the microblog group). The product is more competitive.

In the field of microblog, a topic is an aggregated message list of a kind of related microblog messages. A microblog terminal may create a topic conveniently through inserting a topic in a broadcast distribution box. For example, if only the broadcast message distributed by the microblog terminal includes contents containing “#topic content#”, the microblog terminal may aggregate the broadcast message into a relevant microblog message list according to the “topic content”. A microblog list function is a function for aggregating a certain type of relevant microblog terminals in a terminal list. A microblog list is a list of microblog terminals aggregated according to a certain characteristic. According to the microblog list, one microblog terminal may interact with another microblog terminal of the same type conveniently. The topic function and the list function of the microblog have their own merits and are easy to be used by the microblog terminal. However, there is no association relationship between the two functions in the prior art. With the increasing of the requirements of the microblog terminals, the missing of the association relationship brings inconvenience to the microblog terminals and leads to a bad experience.

In contrast to this, an example of the present disclosure further provides a microblog integrating method, microblog terminal and a microblog list, microblog topic server and system.

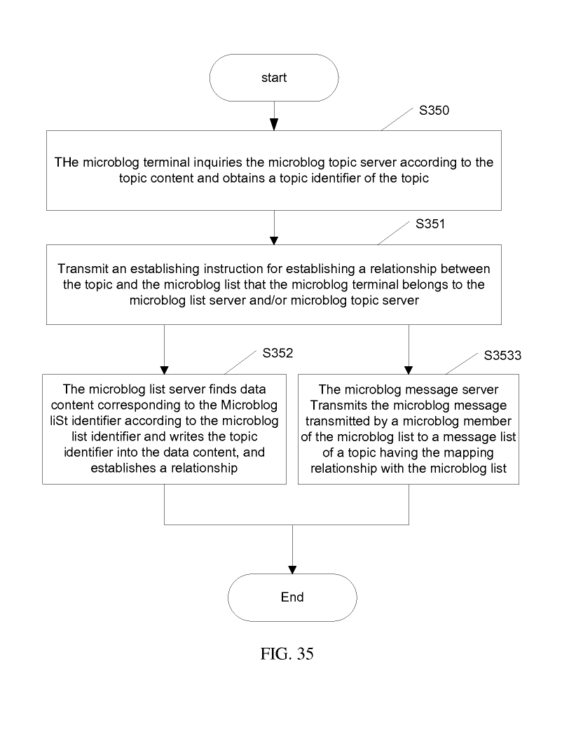

FIG. 35 is a flowchart illustrating a microblog integrating method according to an example of the present disclosure. With reference to FIG. 35, the method includes the following operations.

At block 350, a microblog terminal queries a microblog topic server according to topic and obtains a topic identifier of a topic corresponding to the topic content.

At block 351, an establishing instruction for establishing an association relationship between the topic and a microblog list that the microblog terminal belongs to is transmitted to the microblog list server and/or microblog topic server. The above establishing instruction includes the topic identifier and a microblog list identifier. The association relationship includes a mapping relationship and/or a listening relationship.

At block 352, the microblog list server finds data content corresponding to the microblog list identifier according to the microblog list identifier, writes the topic identifier into the data content and establishing a mapping relationship; and/or

at block 353, the microblog topic server obtains the topic identifier of the topic, finds the data content corresponding to the topic identifier, writes the microblog list identifier into the data content and establishing a listening relationship.

In this example, the microblog (system) mainly includes a microblog terminal and a microblog background server cluster. The microblog terminal mainly includes a microblog message managing module, a microblog group managing module and a microblog topic managing module. The microblog background server cluster may include a microblog topic server, a microblog list server, a microblog message server and a microblog terminal server. The microblog terminal communicates with the microblog background server cluster via an access server.

The microblog message managing module may retrieve and parse message contents according to an ID of the microblog message, and create a message displaying interface to display the message contents. The microblog group managing module may be adapted to create, delete the microblog list, and manage the basic information and the list member (microblog terminal). The microblog topic managing module is mainly adapted to listen to or cancel a topic, retrieve and manage the storage of the listened topic list, and retrieve an ID list of all messages corresponding to a topic.

The microblog terminal corresponding to the creating user of the microblog list may transmit a topic query instruction (e.g., for querying a hot topic list) to the microblog topic server. The microblog topic server may return a topic list which has most messages associated with the user to the microblog terminal. Thus, the microblog terminal may configure a listening relationship between the microblog list and the topic, selects a corresponding topic and transmits a request to the microblog topic server to listen. Therefore, all the microblog terminals in the microblog list can listen to this topic (or, the microblog terminal may also directly transmit a request to the microblog topic server to listen to the corresponding topic). All of the microblog terminals may query the microblog topic server according to the topic identifier, and obtain the ID list of the microblog lists corresponding to the topic, query the microblog list server according to the microblog list identifier. Names and brief description of the microblog list corresponding to the topic may be displayed.

The listening relationship between the microblog list and the topic may be established by the microblog terminal corresponding to the creating user of the microblog list through transmitting an establishing instruction to the microblog topic server for establishing the listening relationship between the topic and the microblog list that the microblog terminal belongs to. The establishing instruction includes a topic identifier and a microblog list identifier. The microblog topic server finds data content corresponding to the topic identifier according to the topic identifier, writes the microblog list identifier into the data content to establish the listening relationship. The data content corresponding to the topic may include: name, description and a listening list of the topic, etc.

The microblog terminal corresponding to the creating user of the microblog list may also select a corresponding topic to establish a mapping relationship. The microblog terminal query the microblog topic server according to the topic content, obtains the topic identifier of the topic, and then transmits an establishing instruction for establishing the mapping relationship between the topic and the microblog list that the microblog terminal belongs to (creates) to the microblog list server. The establishing instruction includes at least the topic identifier and the microblog list identifier of the microblog list. The microblog list server finds data content corresponding to the microblog list identifier according to the microblog list identifier, writes the topic identifier into the data content, so as to establish the mapping relationship between the topic and the microblog list. The data content corresponding to the microblog list identifier may include: name, description, label, permission, member and associated topic, etc.

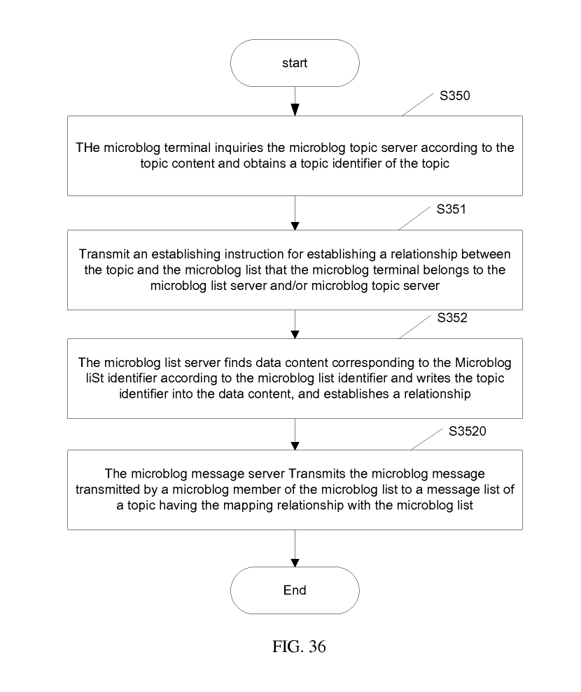

With reference to FIG. 36, the method may include the following operations after block S352.

At block S3520, the microblog message server transmits the microblog message transmitted by the microblog member of the microblog list to a message list of the topic having the mapping relationship with the microblog list.

Block S3520 specifically includes: the microblog message server obtains the microblog list identifier corresponding to the microblog member, determines the topic identifier having the mapping relationship with the microblog list identifier, and writes the microblog message into the message list of the topic identifier.

After the mapping relationship between the topic and the microblog list is established, the microblog messages distributed by all of the microblog terminals in the microblog list will be added to the message list corresponding to the topic automatically. Through creating the topic list having the mapping relationship with the microblog list in the data content corresponding to the microblog list identifier in the microblog list server, when the microblog terminal operates the mapping relationship, the microblog message is inserted into a message list corresponding to the mapping relationship according to a data packet (microblog message) protocol.

When a microblog member (microblog terminal) in the microblog list distributes a microblog message, the microblog message server determines the microblog terminal transmitting the microblog message, queries the microblog list server to obtain a list of microblog list identifiers corresponding to the microblog terminal, traverses the list of the microblog list identifiers to determine a topic identifier list having a mapping relationship with the microblog lists, and traverses the topic identifier list, writes the message identifier of the microblog message distributed by the microblog terminal into the message identifier list corresponding to the topic. As such, when other microblog terminals search for messages corresponding to the topic, the message list of the microblog message distributed by the microblog terminal in the microblog list having the mapping relationship with the topic can be found. An association relationship between the microblog message distributed by the microblog terminal of the microblog list and the topic is established.

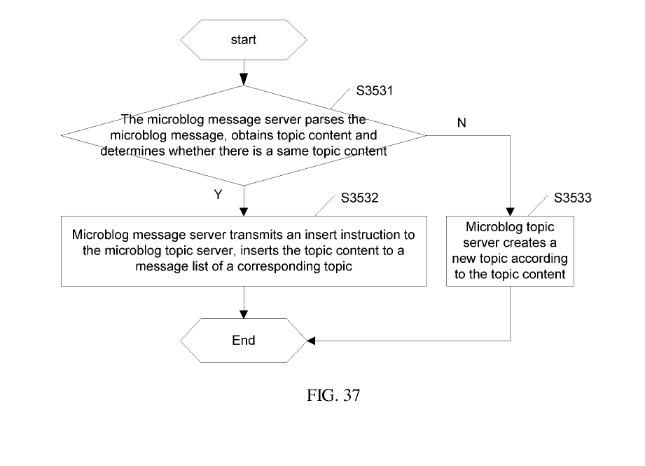

With reference to FIG. 37, the method may further include the following operations after block S353.

At block S3531, the microblog message server parses the received microblog message, obtains topic content and determines whether there is the same topic content.

At block S3532, if there is, the microblog message server transmits an inserting instruction to the microblog topic server to insert the message identifier to the message list of the corresponding topic.

At block S3533, if there is not, the microblog topic server creates a new topic according to the topic content.

The microblog terminal may create a topic in the broadcast distribution window via the microblog message managing module to distribute a microblog message. The microblog message server may receive the microblog message distributed by the microblog terminal and parses the content of the microblog message. The topic content of the microblog message is obtained according to a topic regular (expression) principle. A topic data table is searched according to the topic content to determine whether there is complete matching topic content. If there is, the microblog message server transmits the insert instruction for inserting the message identifier into the topic message list to the microblog topic server. The microblog topic server determines the topic identifier according to the topic content and writes the message identifier corresponding to the microblog message into the message (identifier) list associated with the topic. If there is not, the microblog topic server generates a new topic identifier and inserts corresponding topic content, so as to generate a new topic.

The above microblog terminal includes but is not limited to: Instant Messaging (IM) client, webpage microblog terminal and Wireless Application Protocol (WAP) terminal. Hereinafter, the IM client is taken as an example microblog terminal to describe the microblog integrating method. The above IM client may provide relevant operating and interaction interfaces.

The IM client transmits a microblog account and a password corresponding to the IM client to the microblog terminal server. After the authentication succeeds, a connection between the microblog terminal and the microblog server is established. The connection is maintained through transmitting heartbeat packets to the microblog server periodically.

The IM client monitors user's mouse clicking operation via the microblog message managing module and creates a broadcast distribution window. The user may click an “insert topic” button to call an input controller to insert a topic identifier “#”. The user may input topic content between two “#”. The user may also input other message content in other input area.

When the user clicks the transmit button, the message content in the input box is obtained and integrated in a data packet. After being encrypted, the data packet is transmitted to the microblog message server.

After receiving the message content, the microblog message server parses the data packet. If the data packet is determined as valid, a message index identifier of the message content is generated and is put into a message identifier list corresponding to the distributed messages of the user. At the same time, the message content is parsed. Topic content is obtained through matching according to the regular principle of the topic (#). An instruction for querying topic is transmitted to the microblog topic server.

The microblog message server queries the microblog topic server according to the topic content to determine whether there already exists the topic content in the topic data table. If there is, the microblog topic server inserts the topic content into the message list of the existing topic; if there is not, the microblog topic server generates a new topic according to the topic content.

The microblog terminal corresponding to the creating user of the microblog list transmits an instruction for establishing a listening relationship to the microblog topic server to follow the topic. The microblog terminal in the microblog list may display information such as name and brief description of microblog lists corresponding to the topic.

The microblog terminal corresponding to the creating user of the microblog list may also select a topic to establish a mapping relationship. When the microblog terminal operates the mapping relationship, the microblog message is inserted into a message list corresponding to the mapping relationship according to a data packet (microblog message) protocol The microblog message transmitted by the microblog terminal in the microblog list is transmitted, via the microblog message server, to the message list of the topic having the mapping relationship with the microblog list.

Through the above integrating method, the microblog list associated with the topic may be seen via a topic displaying manner of the microblog list. Thus, one user may find from the topic a microblog list associated with the topic and decide to follow or attempt to follow this microblog list. At the same time, the creating user of the microblog list may make the microblog messages distributed by microblog members (microblog terminals) automatically be added into the message list of the associated topic through establishing the mapping relationship between the microblog list and the topic. As such, a microblog terminal listening to this topic can see microblog messages distributed by the microblog terminals, which realizes the integration of the microblog topic and the microblog list. The microblog terminals may get more resources and the user's experience is improved.

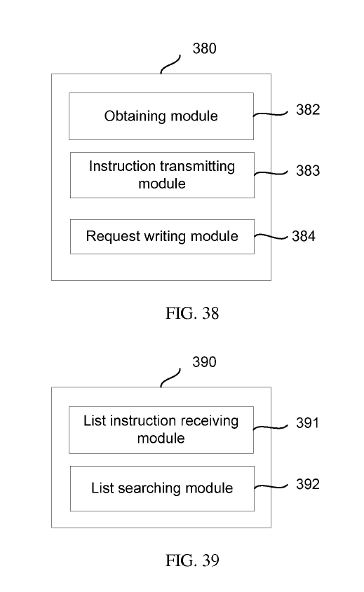

FIG. 38 is a schematic diagram illustrating a microblog terminal according to an example of the present disclosure. With reference to FIG. 38, the microblog terminal 380 may include the following modules: an obtaining module 382, an instruction transmitting module 383 and a writing requesting module 384.

The obtaining module 382 is adapted to query a microblog topic server according to topic content and obtain a topic identifier of a topic corresponding to the topic content.

The instruction transmitting module 383 is adapted to transmit an establishing instruction for establishing an association relationship between the topic and a microblog list that the microblog terminal 380 belongs to a microblog list server and/or the microblog topic server; the establishing instruction includes the topic identifier and a microblog list identifier; the association relationship includes a mapping relationship and/or a listening relationship.

The writing requesting module 384 is adapted to find data content corresponding to the microblog list identifier according to the microblog list identifier through the microblog list server, and write the topic identifier into the data content to establish the mapping relationship; and/or

obtain the topic identifier of the topic through the microblog topic server, find the data content corresponding to the topic and write the microblog list identifier into the data content to establish the listening relationship.

The microblog terminal 380 corresponding to the creating user of the microblog list may transmit a topic query instruction (e.g., hot topic list) to the microblog topic server through the instruction transmitting module 383. The microblog topic server returns a topic list having the most associated messages with the topic query instruction to the microblog terminal 380. As such, the microblog terminal 380 may configure a listening relationship between the microblog list and the topic and select a corresponding topic and transmit a request to the microblog topic server to listen. Thus, all of the microblog terminals 380 in the microblog list can listen to the topic (or, the microblog terminal 380 may directly transmit a request to the microblog topic server to listen to the corresponding topic). Each microblog terminal 380 may query the microblog topic server according to the topic identifier and obtain an ID list of microblog lists corresponding to the topic. Through querying the microblog list server according to the microblog list identifier, information such as name and brief description of the microblog lists corresponding to the topic may be displayed.

The listening relationship between the microblog list and the topic may be established by the microblog terminal 380 corresponding to the creating user of the microblog list through transmitting an establishing instruction to the microblog topic server for establishing the listening relationship between the topic and the microblog list that the microblog terminal belongs to. The establishing instruction includes a topic identifier and a microblog list identifier. The microblog topic server finds data content corresponding to the topic identifier according to the topic identifier, writes the microblog list identifier into the data content to establish the listening relationship. The data content corresponding to the topic may include: name, description and a listening list of the topic, etc.

The microblog terminal 380 corresponding to the creating user of the microblog list may also select a corresponding topic to establish a mapping relationship. The microblog terminal 380 queries the microblog topic server according to the topic content via the obtaining module 382, obtains the topic identifier of the topic, and then transmits an establishing instruction for establishing the mapping relationship between the topic and the microblog list that the microblog terminal 380 belongs to (creates) to the microblog list server via the instruction transmitting module 383. The establishing instruction includes at least the topic identifier and the microblog list identifier of the microblog list. The microblog list server finds data content corresponding to the microblog list identifier according to the microblog list identifier and writes the topic identifier into the data content via the writing requesting module 384, so as to establish the mapping relationship between the topic and the microblog list. The data content corresponding to the microblog list identifier may include: name, description, label, permission, member and associated topic, etc.

Through the above microblog terminal 380, the microblog list associated with the topic may be seen via a topic displaying manner of the microblog list. Thus, one user may find from the topic a microblog list associated with the topic and decide to follow or attempt to follow this microblog list. At the same time, the creating user of the microblog list may make the microblog messages distributed by microblog members (microblog terminals) automatically be added into the message list of the associated topic through establishing the mapping relationship between the microblog list and the topic. As such, a microblog terminal listening to this topic can see microblog messages distributed by the microblog terminals, which realizes the integration of the microblog topic and the microblog list. The microblog terminals may get more resources and the user's experience is improved.

FIG. 39 is a schematic diagram illustrating a structure of a microblog list server 390. With reference to FIG. 39, the microblog list server 390 includes the following modules: a list instruction receiving module 391 and a list searching module 392.

The list instruction receiving module 391 is adapted to receive an establishing instruction transmitted by the microblog terminal 380 for establishing a mapping relationship between a topic and a microblog list that the microblog terminal 380 belongs to. The establishing instruction includes a topic identifier and a microblog list identifier.

The list searching module 392 is adapted to find data content corresponding to the microblog list identifier according to the microblog list identifier and write the topic identifier into the data content.

The microblog terminal 380 queries the microblog topic server according to the topic content, obtains the topic identifier of a topic corresponding to the topic content, and then transmits an establishing instruction for establishing a mapping relationship between the topic and the microblog list that the microblog terminal 380 belongs to (creates) to the microblog list server 390. The establishing instruction includes at least the topic identifier and the microblog list identifier of the microblog list. The microblog list server 390 receives the establishing instruction via the list instruction receiving module 391, finds data content corresponding to the microblog list identifier according to the microblog list identifier via the list searching module 392, writes the topic identifier into the data content, so as to establish the mapping relationship between the topic and the microblog list. The data content corresponding to the microblog list identifier may include: name, description, label, permission, member and associated topic, etc.

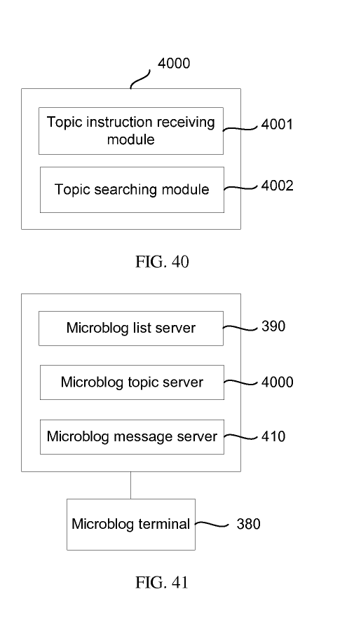

FIG. 40 shows a microblog topic server according to an example of the present disclosure. With reference to FIG. 40, the microblog topic server 4000 includes the following modules: a topic instruction receiving module 4001 and a topic searching module 4002.

The topic instruction receiving module 4001 is adapted to receive an establishing instruction for establishing a listening relationship between a topic and a microblog list that a microblog terminal belongs to transmitted by the microblog terminal 380; the establishing instruction includes a topic identifier and a microblog list identifier.

The topic searching module 4002 is adapted to obtain the topic identifier of the topic, find data content corresponding to the topic identifier and write the microblog list identifier into the data content to establish the listening relationship.

The listening relationship between the microblog list and the topic may be established by the microblog terminal 380 corresponding to the creating user of the microblog list through transmitting an establishing instruction to the microblog topic server 4000 for establishing the listening relationship between the topic and the microblog list that the microblog terminal belongs to. The establishing instruction includes a topic identifier and a microblog list identifier. The topic instruction receiving module 4001 receives the establishing instruction. The microblog topic server finds data content corresponding to the topic identifier according to the topic identifier via the topic searching module 4002, writes the microblog list identifier into the data content to establish the listening relationship. The data content corresponding to the topic may include: name, description and a listening list of the topic, etc.

FIG. 41 shows a microblog system according to an example of the present disclosure. With reference to FIG. 41, the microblog system includes a microblog terminal 380, a microblog topic server 4000 and/or a microblog list server 390. The microblog terminal 380 is adapted to:

query the microblog topic server 4000 according to topic content and obtain a topic identifier of a topic corresponding to the topic content;

transmit an establishing instruction for establishing an association relationship between a topic and a microblog list that the microblog terminal 380 belongs to the microblog list server 390 and/or the microblog topic server 4000; the establishing instruction includes a topic identifier and a microblog list identifier; the association relationship includes a mapping relationship and/or a listening relationship.

The microblog list server 390 is adapted to:

find the data content corresponding to the microblog list identifier according to the microblog list identifier and write the topic identifier into the data content to establish the mapping relationship.

The microblog topic server 4000 is adapted to:

obtain the topic identifier of the topic, find the data content corresponding to the topic identifier, write the microblog list identifier into the data content to establish the listening relationship.

The microblog terminal 380 corresponding to the creating user of the microblog list may transmit a topic query instruction (e.g., hot topic list) to the microblog topic server 4000. The microblog topic server 4000 returns a topic list having the most associated messages with the topic query instruction to the microblog terminal 380. As such, the microblog terminal 380 may configure a listening relationship between the microblog list and the topic, and select a corresponding topic and transmit a request to the microblog topic server 4000 to listen. Thus, all of the microblog terminals 380 in the microblog list can listen to the topic (or, the microblog terminal 380 may directly transmit a request to the microblog topic server 4000 to listen to the corresponding topic). Each microblog terminal 380 may query the microblog topic server 4000 according to the topic identifier, obtain the ID list of the microblog lists corresponding to the topic, and query the microblog list server 390 according to the microblog list identifier. Thus, information such as name and brief description of the microblog lists corresponding to the topic may be displayed.

The listening relationship between the microblog list and the topic may be established by the microblog terminal 380 corresponding to the creating user of the microblog list through transmitting an establishing instruction to the microblog topic server 4000 for establishing the listening relationship between the topic and the microblog list that the microblog terminal 380 belongs to. The establishing instruction includes a topic identifier and a microblog list identifier. The microblog topic server 4000 finds data content corresponding to the topic identifier according to the topic identifier, writes the microblog list identifier into the data content to establish the listening relationship. The data content corresponding to the topic may include: name, description and a listening list of the topic, etc.

The microblog terminal 380 corresponding to the creating user of the microblog list may also select a corresponding topic to establish a mapping relationship. The microblog terminal 380 queries the microblog topic server 4000 according to the topic content, obtains the topic identifier of the topic corresponding to the topic content, and then transmits an establishing instruction for establishing the mapping relationship between the topic and the microblog list that the microblog terminal 380 belongs to (creates) to the microblog list server 390. The establishing instruction includes at least a topic identifier and a microblog list identifier of the microblog list. The microblog list server 390 finds data content corresponding to the microblog list identifier according to the microblog list identifier, writes the topic identifier into the data content, so as to establish the mapping relationship between the topic and the microblog list. The data content corresponding to the microblog list identifier may include: name, description, label, permission, member and associated topic, etc.

The microblog system may further include a microblog message server 410, adapted to transmit a microblog message transmitted by a microblog member in the microblog list to a message list of the topic having mapping relationship with the microblog list.

Specifically, the microblog message server 410 is adapted to obtain the microblog list identifier corresponding to the microblog member, determine the topic identifier having the mapping relationship with the microblog list identifier and write the microblog message into the message list of the topic identifier.

After the mapping relationship between the topic and the microblog list is established, the microblog messages distributed by all of the microblog terminals 380 in the microblog list will be added to the message list corresponding to the topic automatically. Through establishing a topic list corresponding to the microblog list identifier in the data content corresponding to the microblog list identifier in the microblog list server 390, when the microblog terminal operates the mapping relationship, the microblog message is inserted into a message list corresponding to the mapping relationship according to a data packet (microblog message) protocol.

When a microblog member (microblog terminal 380) in the microblog list distributes a microblog message, the microblog message server 410 determines the microblog terminal 380 transmitting the microblog message, queries the microblog list server 390 to obtain an ID list of microblog lists corresponding to the microblog terminal 380, traverses the ID list of the microblog lists to determine an ID list of topics having a mapping relationship with the microblog lists, and traverses the ID list of topics, writes a message identifier of the microblog message distributed by the microblog terminal 380 into a message identifier list of the corresponding topic. As such, when other microblog terminals 380 searches for messages corresponding to the topic, the message list of the microblog message distributed by the microblog terminal 380 in the microblog list having the mapping relationship with the topic can be found. An association relationship between the microblog message distributed by the microblog terminal 380 of the microblog list and the topic is established.

The microblog message server 410 is further adapted to: parse the received microblog message, obtain topic content and query the microblog topic server 4000 to determine whether there is the same topic content; transmit an inserting instruction to the microblog topic server 4000 if there is, and insert the topic content to the message list of the corresponding topic.

The microblog topic server 4000 is further adapted to generate a new topic according to the topic content if there is no same topic content.

The microblog terminal 380 may create a topic in the broadcast distribution window via the microblog message managing module to distribute a microblog message. The microblog message server 410 may receive the microblog message distributed by the microblog terminal 380 and parses the content of the microblog message. The topic content of the microblog message is obtained according to a topic regular (expression) principle. A topic data table is searched according to the data content to determine whether there is complete matching topic content. If there is, the microblog message server 410 transmits an insert instruction to the microblog topic server 4000 to insert the message identifier into the topic message list. The microblog topic server 4000 determines the topic identifier according to the topic content and writes the message identifier corresponding to the microblog message into the message (identifier) list associated with the topic. If there is not, the microblog topic server 4000 generates a new topic identifier and inserts corresponding topic content, so as to generate a new topic.

In the above microblog system, the microblog list associated with the topic may be seen via a topic displaying manner of the microblog list. Thus, one user may find from the topic a microblog list associated with the topic and decide to follow or attempt to follow this microblog list. At the same time, the creating user of the microblog list may make the microblog messages distributed by microblog members (microblog terminals) automatically be added into the message list of the associated topic through establishing the mapping relationship between the microblog list and the topic. As such, a microblog terminal listening to this topic can see microblog messages distributed by the microblog terminals, which realizes the integration of the microblog topic and the microblog list. The microblog terminals may get more resources and the user's experience is improved.

Based on the above descriptions, those with ordinary skill in the art would know that the solution of the present disclosure may be implemented by software accompanying with necessary hardware platform. It is also possible to implement the solution by hardware. Based on this, the solution of the present disclosure or the contribution part of the present disclosure may be expressed by software product in essence. The software product may be stored in a machine readable storage medium (e.g., ROM/RAM, magnetic disk, CD, etc.) and includes machine readable instructions executable by a terminal device (e.g. a personal computer, a server or a network device, etc.) to implement the steps of method provided by the embodiments of the present disclosure.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1.-13. (canceled)

14. A method for distributing a microblog message, comprising:
when a first user is to distribute a microblog message, obtaining, by a first microblog terminal corresponding to the first user, the microblog message to be distributed by the first user, and transmitting the microblog message to a microblog server side;
determining, by the microblog server side, whether a specific area of the microblog message contains account information of a microblog group, if the specific area of the microblog message contains the account information of the microblog group, adding, by the microblog server side, the microblog message into a specific message queue of each member of the microblog group; and
pushing, by the microblog server side, the microblog message in the specific message queue of each member of the microblog group to a microblog terminal corresponding to the member of the microblog group for distribution;
the method further comprises:
after the microblog server side pushes the microblog message in the specific message queue of each member of the microblog group to the microblog terminal corresponding to each member of the microblog group for distribution,
if the member of the microblog group responses to or forwards the microblog message in the specific message queue distributed by the first user, obtaining, by the microblog terminal corresponding to the member, response contents or forward contents, encapsulating the account information of the microblog group and the response contents or the forward contents to generate a response message or forward message, and transmitting the generated response message or forward message to the microblog server side;
adding, by the microblog server side, the response message or the forward message to a broadcast queue of the microblog group according to the account information of the microblog group in the response message or the forward message;
scanning, by the microblog server side, the broadcast queue of the microblog group, pushing the microblog message in the broadcast queue of the microblog group to the first microblog terminal; and
displaying, by the first microblog terminal, the microblog message in the broadcast queue of the microblog group on a group message page.

15. The method of claim 14, wherein the specific area of the microblog message is a predetermined position arranged for a predefined regular expression.

16. The method of claim 15, wherein the determining whether the specific area of the microblog message contains the account information of the microblog group and adding the microblog message into the specific message queue of each member of the microblog group if the specific area of the microblog message contains the account information of the microblog group comprises:
parsing, by the microblog server side, the microblog message according to a regular matching principle, and determining, by the microblog server side, the specific area of the microblog message which matches the predetermined position arranged for the predefined regular expression;
determining, by the microblog server side, whether the specific area of the microblog message contains the account information of the microblog group;
if the specific area of the microblog message contains the account information of the microblog group, querying, by the microblog server side, a member account information list of the microblog group according to the account information of the microblog group; and
adding, by the microblog server side, the microblog message into the specific message queue of each member of the microblog group according to the member account information list.

17. The method of claim 16, further comprising:
if the microblog server side determines that the specific area of the microblog message does not contain the account information of the microblog group, determining, by the microblog server side, whether the specific area of the microblog message contains account information of a second user;
if the specific area of the microblog message contains the account information of the second user, adding, by the microblog server side, the microblog message to a specific message queue of the second user according to the account information of the second user;
scanning, by the microblog server side, the specific message queue of the second user, pushing the microblog message in the specific message queue of the second user to a second microblog terminal corresponding to the second user; and
displaying, by the second microblog terminal, the microblog message in the specific message queue of the second user on a specific message interface.

18. The method of claim 16, wherein the pushing the microblog message in the specific message queue of each member of the microblog group to a microblog terminal corresponding to the member of the microblog group for distribution comprises:
scanning, by the microblog server side, the specific message queue of each member of the microblog group, pushing the microblog message in the specific message queue of each member of the microblog group to a microblog terminal corresponding to the member of the microblog group; and
displaying, by the microblog terminal corresponding to each member of the microblog group, the microblog message in the specific message queue of the member of the microblog group.

19. The method of claim 18, wherein the displaying the microblog message in the specific message queue of the member of the microblog group by the microblog terminal corresponding to each member of the microblog group comprises:
displaying, by the microblog terminal corresponding to each member of the microblog group, a display prompt and a review link for the microblog message in the specific message queue for the member of the microblog group; and
if the member of the microblog group operates the review link, displaying, by the microblog terminal corresponding to the member of the microblog group, the microblog message in the specific message queue on a specific message interface.

20. (canceled)

21. A method for integrating a microblog, comprising:
querying, by a microblog terminal, a microblog topic server according to topic content, and obtaining a topic identifier of a topic;
transmitting an establishing instruction to a microblog list server and/or the microblog topic server to establish an association relationship between the topic and a microblog list that the microblog terminal belongs to, wherein the establishing instruction comprises the topic identifier and a microblog list identifier; the association relationship comprises a mapping relationship and/or a listening relationship;
finding, by the microblog list server, data contents corresponding to the microblog list identifier according to the microblog list identifier and writing the topic identifier into the data content to establishing the mapping relationship; and/or
obtaining, by the microblog topic server, the topic identifier of the topic, finding data contents corresponding to the topic identifier and writing the microblog list identifier into the data contents to establish the listening relationship.

22. The method of claim 21, further comprising:
after finding the data contents corresponding to the microblog list identifier according to the microblog list identifier and writing the topic identifier into the data content to establishing the mapping relationship, transmitting, by a microblog message server, a microblog message transmitted by a microblog member of the microblog list to a message list of the topic having the mapping relationship with the microblog list.

23. The method of claim 22, wherein the transmitting the microblog message transmitted by the microblog member of the microblog list to the message list of the topic having the mapping relationship with the microblog list comprises:
obtaining, by the microblog message server, the microblog list identifier corresponding to the microblog member, determining the topic identifier which has the mapping relationship with the microblog list identifier, and writing the microblog message into the message list of the topic identifier.

24. The method of claim 21, further comprising:
after obtaining the topic identifier of the topic and finding data contents corresponding to the topic identifier and writing the microblog list identifier into the data contents to establish the listening relationship, parsing, by a microblog message server, a microblog message received, obtaining topic content and querying the microblog topic server to determine whether there is same topic content;
if there is the same topic content, transmitting, by the microblog message server, an insert instruction to the microblog topic server to insert the topic content to a message list of the topic; and
if there is no same topic content, creating, by the microblog topic server, a new topic according to the topic content.
